(19) United States
(12) Patent Application Publication
(10) Pub. No.: US 2022/0334513 A1
(43) Pub. Date: Oct. 20, 2022

(54) IMAGE FORMING APPARATUS

(71) Applicant: FUJIFILM Business Innovation Corp., Tokyo (JP)

(72) Inventor: Seigo SHINOZAKI, Ebina-shi (JP)

(73) Assignee: FUJIFILM Business Innovation Corp., Tokyo (JP)

(21) Appl. No.: 17/403,928

(22) Filed: Aug. 17, 2021

(30) Foreign Application Priority Data
Apr. 15, 2021 (JP) 2021-069381

(51) Int. Cl. G03G 15/08; G03G 15/23

(52) U.S. Cl. CPC G03G 15/0867; G03G 15/0894; G03G 15/0848; G03G 15/231

(57) ABSTRACT

An image forming apparatus, includes: plural image forming units each including an image holding member and configured to form an image that is to be transferred to a recording medium on the image holding member using a dry toner, the number of the plural image forming units being at least five; and plural developing devices each of which is provided in each of the plural image forming units and supplied with the dry toner and a dry carrier, each of the plural developing devices including a dry toner adhering unit that has a length equal to or longer than a length of a long side of an A3 size and to which the dry toner adheres, the dry toner adhering unit being configured to cause the dry toner adhering to the dry toner adhering unit to adhere to the image holding member.

### CROSS-REFERENCE TO RELATED APPLICATIONS

This application is based on and claims priority under 35 USC 119 from Japanese Patent Application No. 2021-069381 filed on Apr. 15, 2021.

### BACKGROUND

### Technical Field

The present invention relates to an image forming apparatus.

### Related Art

JP-A-2007-264121 discloses a liquid developing device including a developing tank in which a liquid toner is stored, a pumping roller that pumps out the liquid toner from the developing tank, and a developing roller that supplies the liquid toner pumped up by the pumping roller to a surface of a photosensitive drum.

JP-A-2007-171346 discloses a configuration in which plural developing units that handle respective colors of Y, M, C, and K are provided, and a developer container is disposed in each developing unit.

### SUMMARY

Aspects of non-limiting embodiments of the present disclosure relate to reducing an accommodating volume of a carrier as compared with a case where a wet type developer is used.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: plural image forming units each including an image holding member and configured to form an image that is to be transferred to a recording medium on the image holding member using a dry toner, the number of the plural image forming units being at least five; and plural developing devices each of which is provided in each of the plural image forming units and supplied with the dry toner and a dry carrier, each of the plural developing devices including a dry toner adhering unit that has a length equal to or longer than a length of a long side of an A3 size and to which the dry toner adheres, the dry toner adhering unit being configured to cause the dry toner adhering to the dry toner adhering unit to adhere to the image holding member.

### BRIEF DESCRIPTION OF DRAWINGS

Exemplary embodiment(s) of the present invention will be described in detail based on the following figures, wherein:

FIG. 1 is a diagram illustrating an image forming apparatus according to an exemplary embodiment;

FIG. 2 is a perspective view of a developer supply device;

FIG. 3 is a view of the developer supply device as viewed from a direction III in FIG. 2;

FIG. 4 is a view of the developer supply device as viewed from a direction IV in FIG. 2;

FIG. 5 is a cross-sectional view taken along a line V-V in FIG. 4;

FIG. 6 is a cross-sectional view taken along a line VI-VI in FIG. 4;

FIG. 7 is an enlarged view of a portion VII in FIG. 6;

FIG. 8 is a diagram illustrating a developing device;

FIG. 9 is a view of a developing sleeve viewed from a direction indicated by an arrow IX in FIG. 8;

FIG. 10 is a schematic diagram illustrating functions of the image forming apparatus;

FIG. 11 is a diagram illustrating another configuration example of the image forming apparatus;

FIG. 12 is a diagram illustrating another configuration example of the image forming apparatus;

FIG. 13 is a diagram illustrating another configuration example of the image forming apparatus;

FIG. 14 is a diagram illustrating another configuration example of the image forming apparatus; and

FIG. 15 is a diagram illustrating another configuration example of the image forming apparatus.

### DETAILED DESCRIPTION

Hereinafter, an exemplary embodiment of the present disclosure will be described with reference to the accompanying drawings.

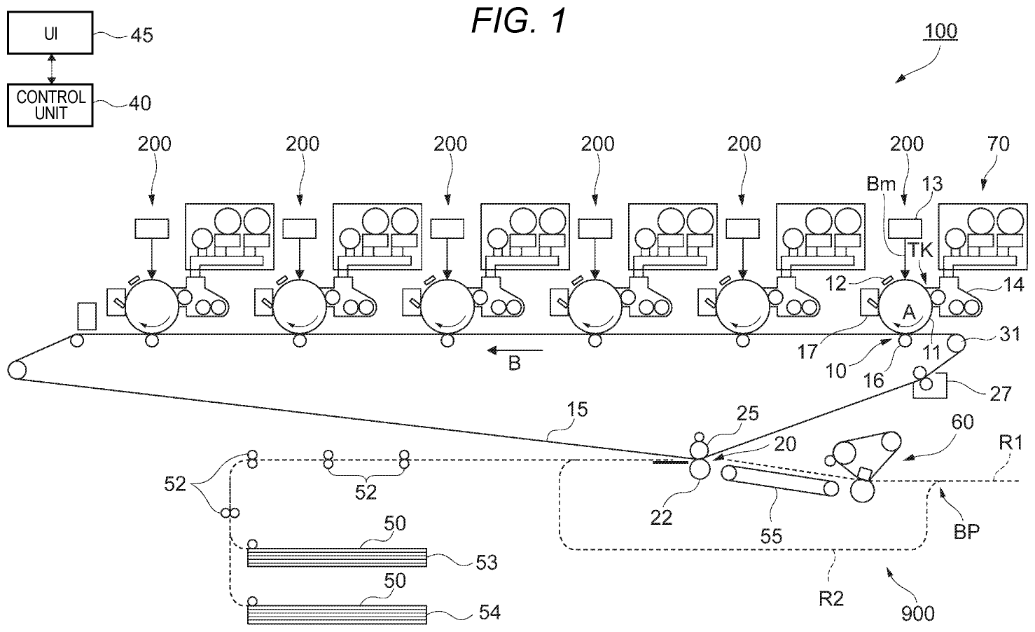

FIG. 1 is a diagram illustrating an image forming apparatus 100 according to the present exemplary embodiment.

The image forming apparatus 100 is an image forming apparatus 100 of an intermediate transfer type, called a tandem type.

At least five image forming units 200 that form an image to be transferred to a sheet 50, which is an example of a recording medium, are provided in the image forming apparatus 100. The number of the image forming units 200 that are provided may be five or more, and in the present exemplary embodiment, the number of the image forming units 200 that are provided is six.

Each of the image forming units 200 includes a photosensitive drum 11 as an example of an image holding member, and forms a toner image, which is an image transferred to the sheet 50, on the photosensitive drum 11 using a dry developer. In other words, each of the image forming units 200 forms the toner image transferred to the sheet 50 on the photosensitive drum 11 using a powdery developer.

A developer of the present exemplary embodiment includes a powdery dry carrier and a powdery dry toner, and each of the image forming units 200 forms the toner image on the photosensitive drum 11 using the powdery dry carrier and the powdery dry toner.

When the dry developer is used in this manner, an accommodating volume of a carrier may be reduced as compared with a case of using a wet type developer.

The six image forming units 200 form toner images on the photosensitive drums 11 by using dry toners having different types from each other.

Specifically, in the present exemplary embodiment, the four image forming units 200 of the six image forming units 200 form the toner images by using the dry toners of basic colors of yellow, magenta, cyan, and black.

The remaining two image forming units 200 form the toner images by using the dry toners of special colors such as clear, white, gold, silver, pink, green, and orange.

A type of the dry toners is not limited thereto, and examples thereof include a dry toner having magnetism or a dry toner having conductivity. Examples of the type of the dry toners include a dry toner that emits light by irradiation with light such as ultraviolet light or infrared light.

The “dry toners having different types from each other” include not only the dry toners having different colors but also the dry toners having different functions and properties.

For example, even when the colors of the two dry toners are the same, when one of the two dry toners is the dry toner having magnetism and the other is the dry toner having conductivity, it may be said that the two types of the dry toners are different.

Plural image forming units 200 using the dry toners are provided in the present exemplary embodiment, and other image forming units 200 may be provided in addition to these image forming units 200.

Specifically, for example, the image forming unit 200 that forms the toner image using only the dry toner without using a dry carrier, or the image forming unit 200 that forms an image by an inkjet method may be additionally provided.

In the image forming apparatus 100, an intermediate transfer belt 15 and a primary transfer unit 10 for transferring the toner images formed by each of the image forming units 200 to the intermediate transfer belt 15 are provided.

Further, the image forming apparatus 100 is provided with a secondary transfer unit 20 for transferring the toner image transferred onto the intermediate transfer belt 15 to the sheet 50.

Further, the image forming apparatus 100 is provided with a fixing device 60 that fixes the toner image transferred to the sheet 50 onto the sheet 50.

Further, the image forming apparatus 100 is provided with a control unit 40, which includes a CPU that executes a program and controls each unit in the image forming apparatus 100.

Further, the image forming apparatus 100 is provided with a user interface (UI) 45 configured by a display panel or the like and configured to receive an instruction from a user and to display information to the user.

Each of the image forming units 200 is provided with a developing device 14. Each of the image forming units 200 is provided with a developer replenishing device 70 that replenishes the developer to the developing device 14.

The developing device 14 visualizes an electrostatic latent image on the photosensitive drum 11 with the dry toner.

The developer replenishing device 70 replenishes the developer to the developing device 14. The developer includes the dry carrier and the dry toner having magnetism, and the developer replenishing device 70 replenishes the developing device 14 with the dry carrier and the dry toner.

In this example, the dry carrier has a positive charging polarity, and the dry toner has a negative charging polarity.

Further, in each of the image forming units 200, the photosensitive drum 11 as the example of the image holding member rotates in a direction of an arrow A.

Each of the image forming units 200 is provided with a charger 12 that charges the photosensitive drum 11 and a laser exposure device 13 as an example of an exposure device that forms the electrostatic latent image on the photosensitive drum 11. The exposure device may be configured by a device including plural light sources such as LEDs. In FIG. 1, an exposure beam caused by the laser exposure device 13 is denoted by a reference numeral Bm.

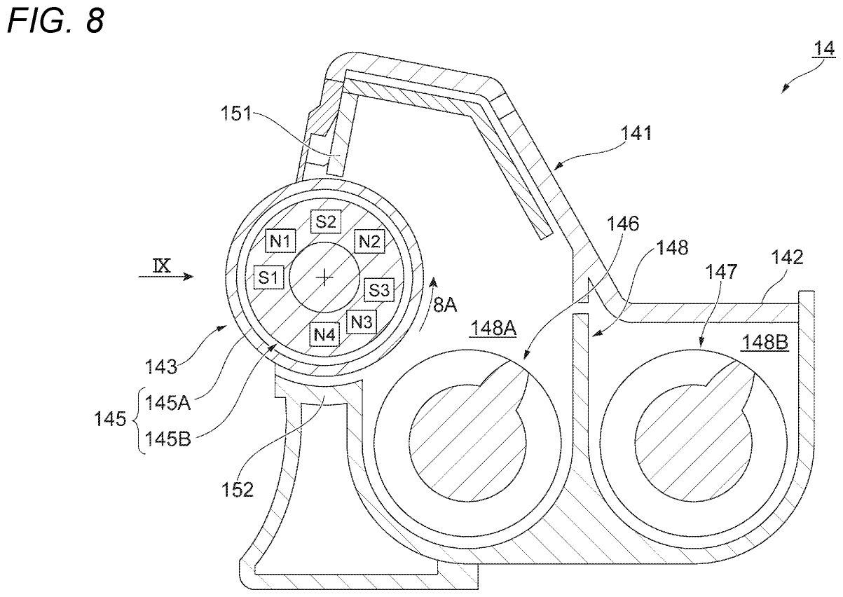

FIG. 8 is a diagram illustrating the developing device 14.

The developing device 14 includes an accommodating unit 141 that accommodates the developer. The accommodating unit 141 is formed of, for example, a resin accommodating housing 142.

The developing device 14 is disposed so as to extend in a direction (a direction orthogonal to a paper surface of FIG. 1) from a front side to a rear side of the image forming apparatus 100.

The accommodating housing 142 is provided with an opening 143 at a position facing the photosensitive drum 11 (see FIG. 1).

The opening 143 is provided with a developing roller 145 for adhering the developer to a surface of the photosensitive drum 11.

The developing roller 145 is formed in a cylindrical shape, and is disposed so as to extend in the direction (the direction orthogonal to the paper surface of FIG. 1) from the front side to the rear side of the image forming apparatus 100.

The developing roller 145 is provided with a developing sleeve 145A formed of a cylindrical body and performing rotational driving, and a magnet roller 145B disposed inside the developing sleeve 145A.

The developing sleeve 145A as an example of a dry toner adhering unit is made of a metal such as SUS.

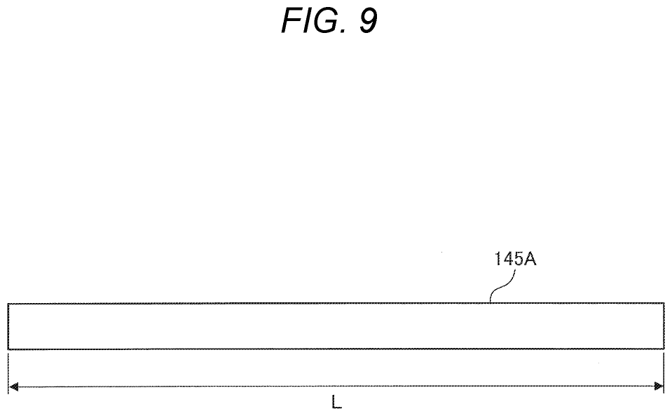

FIG. 9 is a view of the developing sleeve 145A viewed from a direction indicated by an arrow IX in FIG. 8.

As shown in FIG. 9, in the developing sleeve 145A of the present exemplary embodiment, a length L in an axial direction is equal to or longer than a length of a long side of an A3 size.

More specifically, the long side of the A3 size is 420 mm, and the length L in the axial direction of the developing sleeve 145A of the present exemplary embodiment is 420 mm or more.

The developing sleeve 145A rotates in a direction of an arrow 8A in FIG. 8. In other words, the developing sleeve 145A rotates such that a portion located inside the accommodating unit 141 moves upward.

Further, in the present exemplary embodiment, the developing sleeve 145A and the photosensitive drum 11 rotate such that the developing sleeve 145A and the photosensitive drum 11 move in the same direction in a facing portion TK (see FIG. 1) between the developing roller 145 and the photosensitive drum 11.

In the present exemplary embodiment, a length of the photosensitive drum 11 in the axial direction is equal to or longer than the length of the long side of the A3 size. As shown in FIG. 8, the developing device 14 is provided with a first conveying member 146 and a second conveying member 147 that convey the developer.

The first conveying member 146 and the second conveying member 147 sandwich the developing roller 145, and are provided on an opposite side of an installation side of the photosensitive drum 11 (see FIG. 1).

Further, in the present exemplary embodiment, the first conveying member 146 is provided on a side close to the photosensitive drum 11, and the second conveying member 147 is provided on a side away from the photosensitive drum 11.

The first conveying member 146 is disposed to extend from the front side to the rear side of the image forming apparatus 100, and conveys the developer to, for example, the rear side of the image forming apparatus 100.

The second conveying member 147 is also disposed so as to extend from the front side to the rear side of the image forming apparatus 100, and conveys the developer to the front side of the image forming apparatus 100.

In the present exemplary embodiment, a length of the first conveying member 146 and the second conveying member 147 in the axial direction is equal to or longer than the length of the long side of the A3 size.

Further, in the present exemplary embodiment, a space inside the accommodating housing 142 is partitioned by a partition wall 148, and a first space 148A located on a photosensitive drum 11 side and a second space 148B located on the side away from the photosensitive drum 11 are provided inside the accommodating housing 142.

In the present exemplary embodiment, the first conveying member 146 is provided in the first space 148A, and the second conveying member 147 is provided in the second space 148B.

The partition wall 148 is not formed over an entire region of the accommodating housing 142 in a longitudinal direction. The partition wall 148 is not provided on a back side and a front side of the accommodating housing 142.

At both end portions of the accommodating housing 142 in the longitudinal direction, there is a non-formed portion where the partition wall 148 is not formed.

As a result, in the present exemplary embodiment, the developer circulates and moves inside the developing device 14.

Specifically, in the present exemplary embodiment, the developer in the first space 148A is conveyed by the first conveying member 146 toward a back side direction of the paper surface of FIG. 8.

Then, when the developer reaches an end portion of the accommodating housing 142 on the back side, the developer moves to the second space 148B through the non-formed portion.

The developer that moves to the second space 148B is conveyed by the second conveying member 147 toward a front side direction of the paper surface of FIG. 8. Then, the developer moves to the first space 148A through the non-formed portion provided at an end portion of the accommodating housing 142 on the front side.

Thereafter, this movement of the developer is repeatedly performed, and circulation movement of the developer is performed inside the developing device 14. Further, in the present exemplary embodiment, the developer is stirred by the circulation movement of the developer.

In the present exemplary embodiment, a length of the accommodating housing 142 in the same direction as the length of the developing sleeve 145A in the axial direction is equal to or longer than the length of the long side of the A3 size.

Further, the developing device 14 is provided with a layer regulating portion 151 above the developing roller 145. The layer regulating portion 151 is disposed in a state of having a gap between the layer regulating portion 151 and the developing roller 145.

The layer regulating portion 151 regulates a movement of a part of the developer adhering to a surface of the developing roller 145, and sets a thickness of the developer adhering to the surface of the developing roller 145 to a predetermined thickness.

The developing device 14 is provided with a lower facing portion 152 facing the developing roller 145 below the developing roller 145.

In the present exemplary embodiment, the opening 143 is provided between the layer regulating portion 151 and the lower facing portion 152, and the developing roller 145 is provided in the opening 143.

The magnet roller 145B is provided with seven magnetic poles N1 to N4 (N poles) and S1 to S3 (S poles) arranged along a circumferential direction of the magnet roller 145B.

The magnetic pole N3 (pickup pole) sucks the developer conveyed by the first conveying member 146. As a result, in the present exemplary embodiment, the developer adheres to a surface of the developing sleeve 145A as an example of the dry toner adhering unit.

In the magnetic pole S2 (trimming pole), the thickness of the developer adhering to the surface of the developing roller 145 is set to the predetermined thickness together with the layer regulating portion 151.

The magnetic poles S3, N2, and N1 serve as a conveying pole, and move the developer on the developing sleeve 145A to a downstream side of the developing sleeve 145A in a rotational direction.

The magnetic pole S1 (developing pole) forms a developer napping together with an adjacent magnetic pole N1. In the present exemplary embodiment, the dry toner contained in the developer in a standing state moves to the surface of the photosensitive drum 11 (see FIG. 1), and the dry toner adheres to the photosensitive drum 11 as the example of the image holding member.

As a result, development is performed, and the toner image is formed on the photosensitive drum 11.

The toner image is temporarily held by the photosensitive drum 11, and moves to the primary transfer unit 10 by the rotating photosensitive drum 11.

The magnetic pole N4 (pick-off pole) forms a repulsive magnetic field together with the adjacent magnetic pole N3, and separates the developer adhering to the surface of the developing sleeve 145A from the developing sleeve 145A.

In the present exemplary embodiment, a length of the layer regulating portion 151, the lower facing portion 152, and the opening 143 in the same direction as the length of the developing sleeve 145A in the axial direction is equal to or longer than the length of the long side of the A3 size.

The image forming apparatus 100 will be further described with reference to FIG. 1 again.

Each of the image forming units 200 is provided with a primary transfer roller 16 that transfers the toner image formed on the photosensitive drum 11 to the intermediate transfer belt 15 at the primary transfer unit 10.

Each of the image forming units 200 is provided with a drum cleaner 17 that removes the developer remaining on the photosensitive drum 11.

The intermediate transfer belt 15 circulates and moves at a predetermined speed in a direction of an arrow B shown in FIG. 1 by a drive roller 31 driven by a motor (not shown).

The primary transfer unit 10 includes the primary transfer roller 16 that is disposed to face the photosensitive drum 11 with the intermediate transfer belt 15 interposed therebetween. Then, the toner images on the respective photosensitive drums 11 are sequentially electrostatically attracted to the intermediate transfer belt 15, and superimposed toner images are formed on the intermediate transfer belt 15.

The secondary transfer unit 20 as an example of a transfer unit includes a secondary transfer roller 22 disposed on an outer surface side of the intermediate transfer belt 15, and a backup roller 25 disposed on an inner surface side of the intermediate transfer belt 15. In the present exemplary embodiment, in the secondary transfer unit 20, the toner image formed by the image forming unit 200 and transferred onto the intermediate transfer belt 15 is transferred to the sheet 50 conveyed to the secondary transfer unit 20.

Further, in the present exemplary embodiment, a reversing mechanism 900 that reverses the sheet 50 is provided.

The reversing mechanism 900 reverses front and back sides of the sheet 50 having the toner image transferred to one surface of the sheet 50 by the secondary transfer unit 20, and supplies the sheet 50 to the secondary transfer unit 20 again.

As a result, in the present exemplary embodiment, it is possible to form the toner images on both surfaces of the sheet 50.

Specifically, in the present exemplary embodiment, the reversing mechanism 900 reverses the front and back sides of the sheet 50 by feeding the sheet 50 after passing through the fixing device 60 to a branch route R2 branched from a sheet conveying route R1. Specifically, after the sheet 50 passes through a branch portion BP, the reversing mechanism 900 conveys the sheet 50 in a reverse direction and further feeds the sheet 50 to the branch route R2.

The branch route R2 merges with the sheet conveying route R1 on an upstream side of the secondary transfer unit 20. As a result, in the present exemplary embodiment, the sheet 50 in a state in which the front and back sides are reversed is supplied again to the secondary transfer unit 20. In this case, the toner image is formed not only on the one surface of the sheet 50 but also on the other surface of the sheet 50, and the toner image is formed on the both surfaces of the sheet 50.

In the image forming apparatus 100 according to the present exemplary embodiment, the toner image is formed on the sheet 50 having a large size such as an A2 size, and the toner image may be formed on the both surfaces of the sheet 50.

In this case, for example, it is possible to easily form a large bulletin board which may be visually recognized from the both surfaces by being attached to glass or the like.

In addition, in a case where plural paper products are manufactured by cutting out and further assembling the sheet 50 after the image is formed, when the sheet 50 itself on which the toner image is formed is large as in the present exemplary embodiment, manufacturing efficiency of the paper products is increased. Specifically, the number of the paper products manufactured from one sheet 50 may be increased, and the manufacturing efficiency of the paper products may be increased.

A flow of processing performed by the image forming apparatus 100 will be described.

The image forming apparatus 100 receives, for example, image data output from an image reading device (not shown) or the like. Then, the image data is subjected to an image processing. As a result, the image data corresponding to each of the plural image forming units 200 is generated.

Specifically, for example, the image data for four colors of yellow, magenta, cyan, and black and the image data for special colors are generated. The generated image data is output to the laser exposure device 13 provided in the image forming unit 200.

The laser exposure device 13 irradiates the photosensitive drum 11 with the exposure beam Bm emitted from, for example, a semiconductor laser in accordance with the input image data.

In the present exemplary embodiment, after the surface of each photosensitive drum 11 is charged by the charger 12, scanning exposure to the surface is performed by the laser exposure device 13. As a result, the electrostatic latent image is formed on the surface of the photosensitive drum 11.

Next, a developing processing is performed by the developing device 14, and the toner image is formed on the photosensitive drum 11. The toner image is transferred onto the intermediate transfer belt 15 in the primary transfer unit 10.

After the toner image is transferred onto the intermediate transfer belt 15, the toner image moves to the secondary transfer unit 20 by the movement of the intermediate transfer belt 15. At this time, the sheet 50 from a first sheet accommodating unit 53 or a second sheet accommodating unit 54 is conveyed to the secondary transfer unit 20 by conveying rollers 52, or the like.

Then, the toner images on the intermediate transfer belt 15 are collectively electrostatically transferred onto the sheet 50 in the secondary transfer unit 20.

Thereafter, the sheet 50 to which the toner images are transferred is separated from the intermediate transfer belt 15 and conveyed to a conveyance belt 55. The conveyance belt 55 conveys the sheet 50 to the fixing device 60.

The sheet 50 conveyed to the fixing device 60 is heated and pressed by the fixing device 60. As a result, the toner images on the sheet 50 are fixed to the sheet 50. The sheet 50 is discharged from the image forming apparatus 100.

When the toner images are formed on the both surfaces of the sheet 50, after the sheet 50 passes through the fixing device 60, the sheet 50 is again supplied to the secondary transfer unit 20 through the branch route R2.

Then, the toner images are transferred to the other surface of the sheet 50 in the secondary transfer unit 20. Thereafter, the sheet 50 again passes through the fixing device 60, and the toner images transferred to the other surface of the sheet 50 is fixed to the sheet 50.

(Configuration of Developer Replenishing Device)

Next, the developer replenishing device 70 will be described.

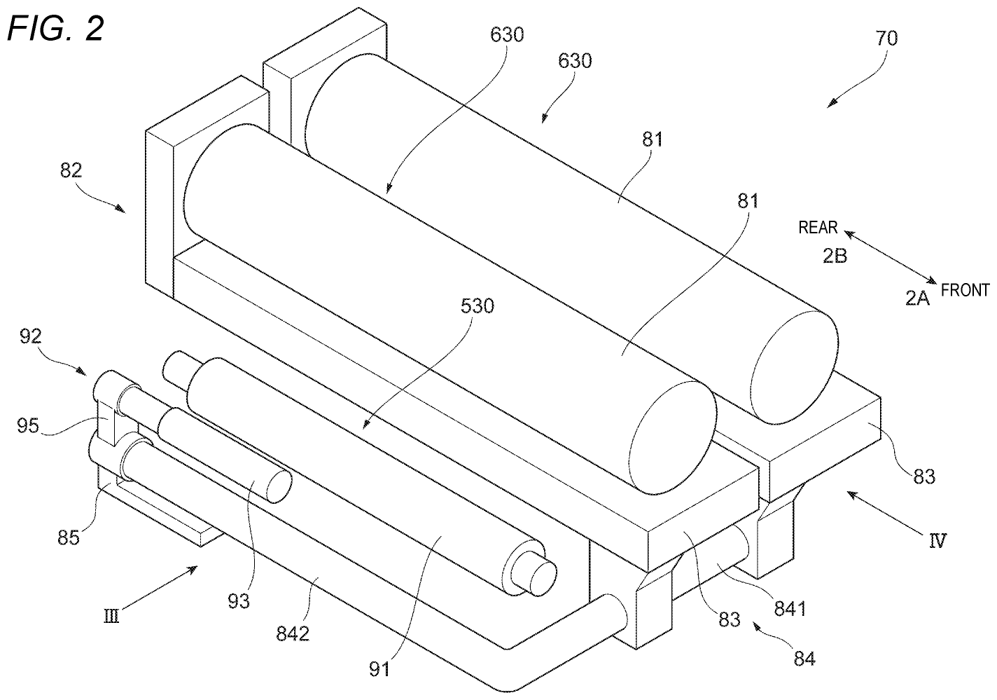

FIG. 2 is a perspective view of the developer replenishing device 70. In FIG. 2, a lower right side is a front side of the image forming apparatus 100, and an upper left side is a rear side of the image forming apparatus 100. In other words, in FIG. 2, the lower right side is the front side of the image forming apparatus 100, and the upper left side is the rear side of the image forming apparatus 100.

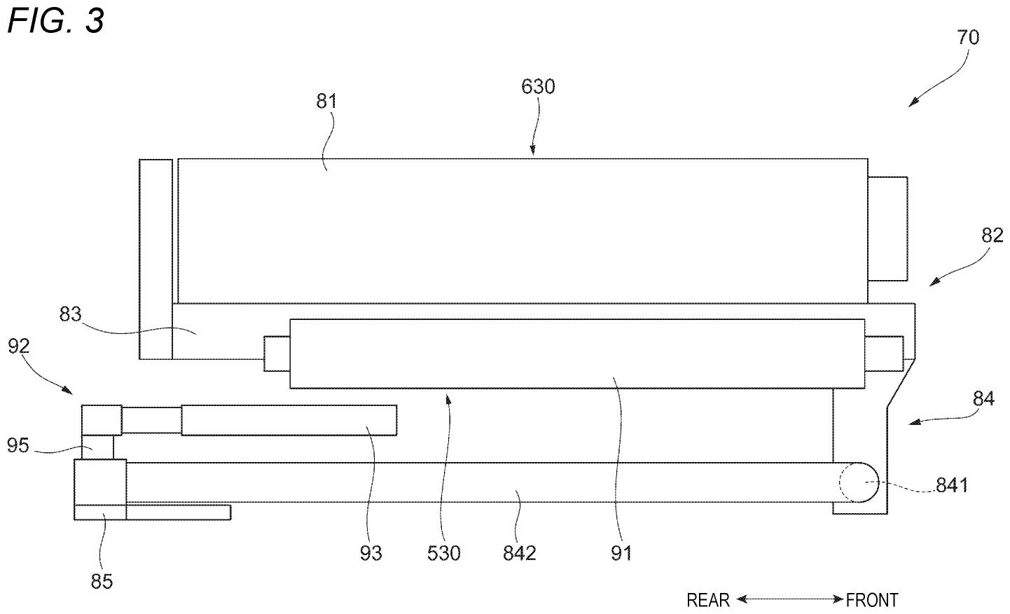

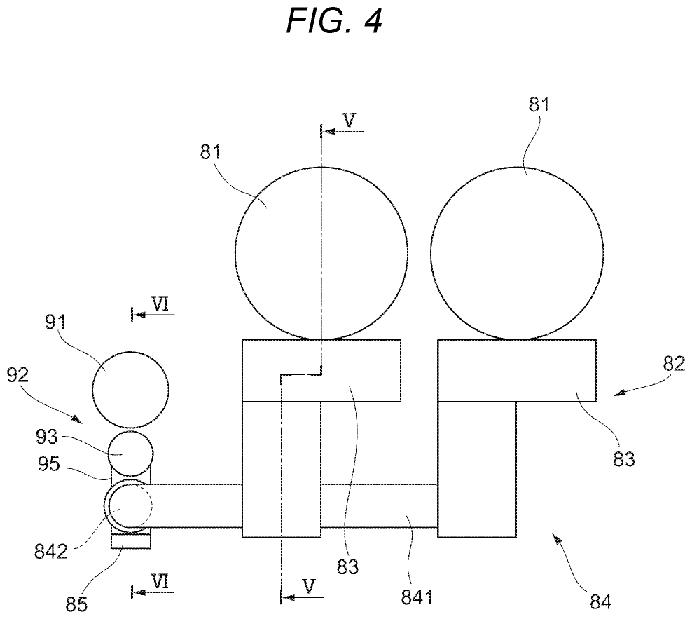

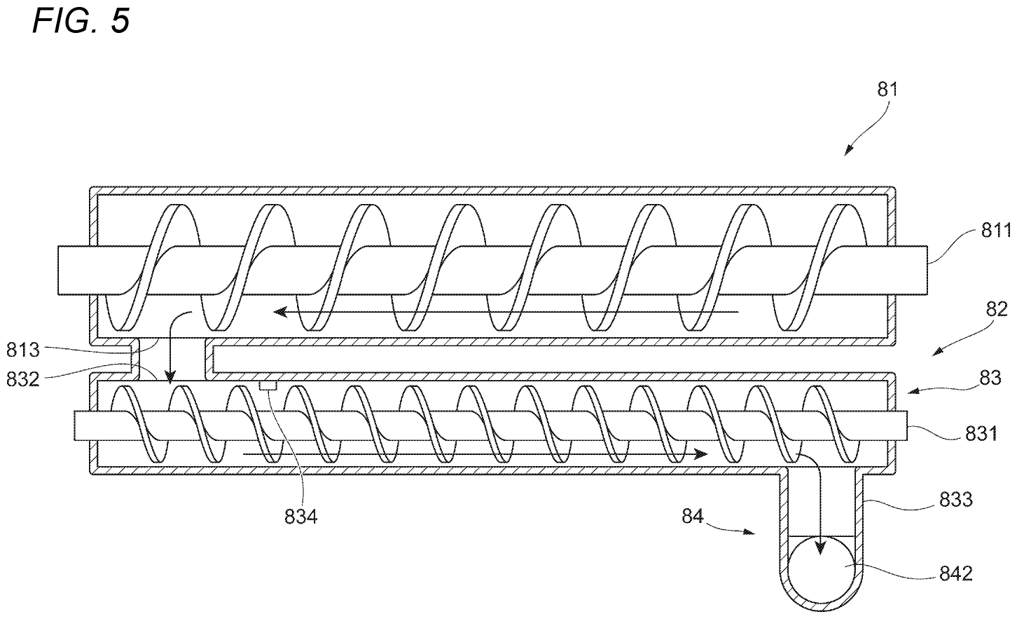

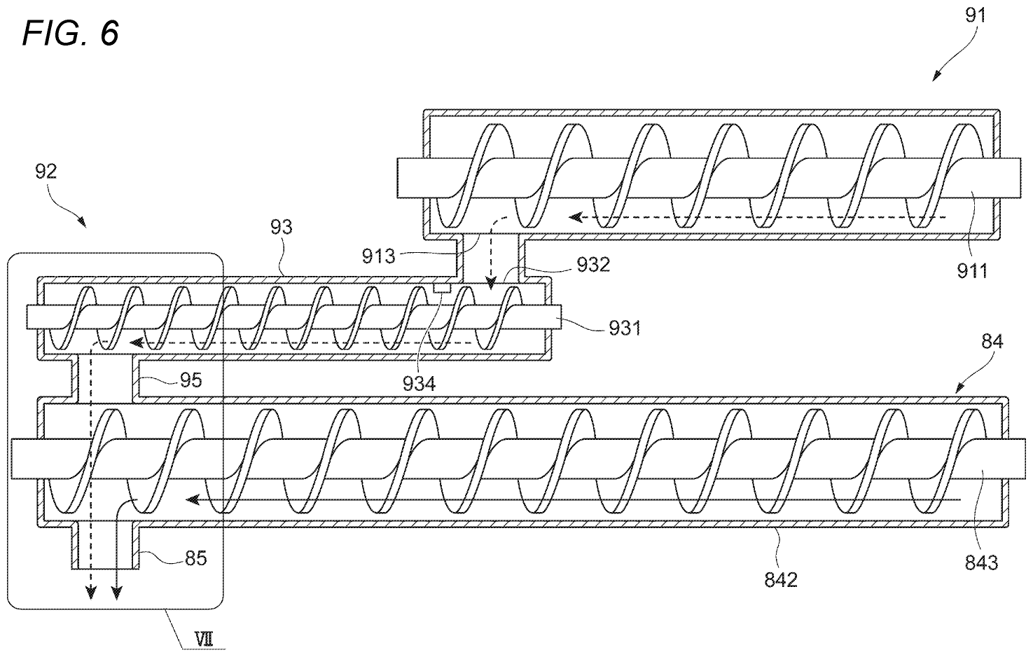

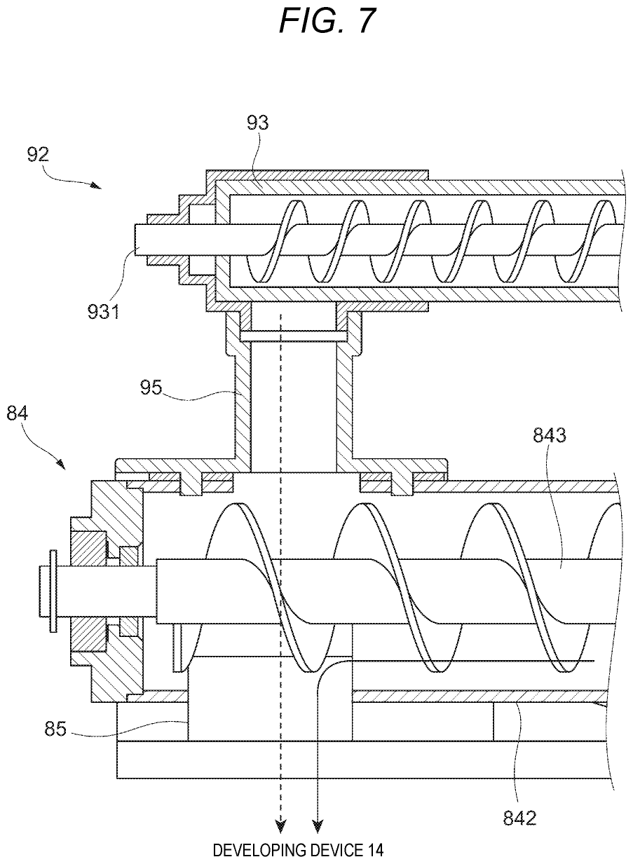

FIG. 3 is a view of the developer replenishing device 70 as viewed from a direction III in FIG. 2. FIG. 4 is a view of the developer replenishing device 70 as viewed from a direction IV (that is, front side) in FIG. 2. FIG. 5 is a cross-sectional view taken along a line V-V in FIG. 4. FIG. 6 is a cross-sectional view taken along a line VI-VI in FIG. 4. FIG. 7 is an enlarged view of a portion VII in FIG. 6.

As shown in FIG. 2, the developer replenishing device 70 includes two toner accommodating units 630 that accommodate the dry toners and a toner dispenser 82.

In the present exemplary embodiment, a toner cartridge 81 that accommodates the dry toner therein is provided in each of the toner accommodating units 630. Two toner cartridges 81 have the same configuration.

The toner dispenser 82 as an example of a toner replenishing unit receives the dry toner from each of the toner accommodating units 630, and replenishes the dry toner to the developing device 14 (see FIG. 1).

The toner accommodating unit 630 is provided at a position different from the developing device 14 (see FIG. 1).

In the present exemplary embodiment, the dry toner newly supplied from the outside of the image forming apparatus 100 is accommodated in the toner accommodating unit 630.

Specifically, in the present exemplary embodiment, the new dry toner is supplied to the toner accommodating unit 630 by mounting the toner cartridge 81, which is an example of an accommodating container that accommodates the dry toner, on the toner accommodating unit 630.

In the present exemplary embodiment, all parts of the toner cartridge 81 are accommodated inside the image forming apparatus 100, and the present disclosure is not limited to this, and a part of the toner cartridge 81 may be exposed to the outside of the image forming apparatus 100.

Further, the toner accommodating unit 630 is not in a form in which the toner cartridge 81 is mounted, and the toner accommodating unit 630 may be an accommodating chamber that accommodates the dry toner.

In this case, for example, the user manually puts only the dry toner into the toner accommodating unit 630.

Alternatively, for example, a transfer container used for transferring the dry toner is temporarily connected to a toner accommodating chamber, and the dry toner is automatically transferred from the transfer container to the toner accommodating chamber. After the dry toner is transferred from the transfer container to the toner accommodating chamber, the transfer container is removed.

In addition, the developer replenishing device 70 is provided with a carrier accommodating unit 530 that accommodates the dry carrier and a carrier dispenser 92. The carrier dispenser 92 as an example of a carrier replenishing unit receives the dry carrier from the carrier accommodating unit 530 and replenishes the dry carrier to the developing device 14 (see FIG. 1).

In the present exemplary embodiment, a carrier cartridge 91 that accommodates the dry carrier therein is provided in the carrier accommodating unit 530. In this example, one carrier cartridge 91 is provided in the developer replenishing device 70, unlike the toner cartridges 81.

The carrier dispenser 92 as the example of the carrier replenishing unit receives the dry carrier from the carrier cartridge 91 provided in the carrier accommodating unit 530, and replenishes the dry carrier to the developing device 14 (see FIG. 1).

The carrier accommodating unit 530 is provided at a position different from the developing device 14 (see FIG. 1).

In the present exemplary embodiment, the dry carrier newly supplied from the outside of the image forming apparatus 100 is accommodated in the carrier accommodating unit 530.

Specifically, in the present exemplary embodiment, the new dry carrier is supplied to the carrier accommodating unit 530 by mounting the carrier cartridge 91, which is an example of the accommodating container that accommodates the dry carrier, on the carrier accommodating unit 530.

In the present exemplary embodiment, all parts of the carrier cartridge 91 are accommodated inside the image forming apparatus 100, and the present disclosure is not limited to this, and a part of the carrier cartridge 91 may be exposed to the outside of the image forming apparatus 100.

Further, the carrier accommodating unit 530 is not in a form in which the carrier cartridge 91 is mounted, and the carrier accommodating unit 530 may be the accommodating chamber that accommodates the dry carrier.

In this case, for example, the user manually puts only the dry carrier into the carrier accommodating unit 530.

Alternatively, for example, the transfer container used for transferring the dry carrier is temporarily connected to a carrier accommodating chamber, and the dry carrier is automatically transferred from the transfer container to the carrier accommodating chamber. After the dry carrier is transferred from the transfer container to the carrier accommodating chamber, the transfer container is removed.

Each of the toner cartridges 81 is disposed so as to extend in a front-rear direction of the image forming apparatus 100. Each of the toner cartridges 81 has a cylindrical shape. Each of the toner cartridges 81 is attachable to and detachable from a device body of the developer replenishing device 70.

Specifically, the toner cartridge 81 is removed from the developer replenishing device 70 by being pulled out to the front side of the developer replenishing device 70. Further, the toner cartridge 81 is mounted on the developer replenishing device 70 by pushing the toner cartridge 81 to a rear side of the developer replenishing device 70.

Specifically, a direction indicated by an arrow 2A is a removal direction of the toner cartridge 81, and a direction indicated by an arrow 2B is a mounting direction of the toner cartridge 81.

As shown in FIG. 5, a toner stirring member 811 that stirs the dry toner is provided inside the toner cartridge 81.

The toner stirring member 811 is rotationally driven by a drive motor (not shown), and stirs the dry toner inside the toner cartridge 81. Further, the toner stirring member 811 conveys the dry toner from a front side to a rear side of the toner cartridge 81.

A conveyance direction of the dry toner inside the toner cartridge 81 is along an attachment and detachment direction when attaching and detaching the toner cartridge 81. In the present exemplary embodiment, “along the attachment and detachment direction” is not necessarily to be parallel to the attachment and detachment direction, and the conveyance direction may have at least a component in the attachment and detachment direction.

The toner cartridge 81 includes a toner discharge unit 813. The dry toner conveyed by the toner stirring member 811 is discharged from the toner discharge unit 813 and supplied to the toner dispenser 82. Specifically, the dry toner is supplied to a toner reserve tank 83 provided in the toner dispenser 82.

The toner discharge unit 813 is provided in the rear side of the toner cartridge 81. The toner discharge unit 813 is provided on a lower side surface of surfaces of the toner cartridge 81 facing the toner reserve tank 83.

As shown in FIG. 2, the toner dispenser 82 is provided with two toner reserve tanks 83 that accommodate the dry toners received from the toner cartridges 81. The two toner reserve tanks 83 have the same configuration.

As shown in FIG. 3, the toner dispenser 82 is provided with a toner conveying unit 84 that receives the dry toners from the two toner reserve tanks 83 and conveys the dry toners toward the developing device 14 (see FIG. 1).

Further, as shown in FIG. 6, the toner dispenser 82 is provided with a toner charging unit 85 that charges the dry toner conveyed through the toner conveying unit 84 into the developing device 14.

As shown in FIG. 2, each of the toner reserve tanks 83 extends in the front-rear direction of the developer replenishing device 70 and has a box shape. Each of the toner reserve tanks 83 is provided vertically below the toner cartridge 81.

As shown in FIG. 5, a toner conveying member 831 for conveying the dry toner while stirring the dry toner is provided inside the toner reserve tank 83.

The toner conveying member 831 is rotationally driven by the drive motor (not shown), and stirs the dry toner inside the toner reserve tank 83. The toner conveying member 831 conveys the dry toner from the rear side to the front side of the toner reserve tank 83.

In the present exemplary embodiment, the conveyance direction of the dry toner in the toner reserve tank 83 is opposite to the conveyance direction of the dry toner in the toner cartridge 81.

Further, in the present exemplary embodiment, the conveyance direction of the dry toner in the toner reserve tank 83 is along the attachment and detachment direction when attaching and detaching the toner cartridge 81.

As the toner conveying member 831, for example, a conveying member including a rotation shaft extending in the front-rear direction of the toner reserve tank 83 and a blade portion spirally formed around the rotation shaft is exemplified.

In the present exemplary embodiment, as shown in FIG. 5, a toner detector 834 is provided inside the toner reserve tank 83. The toner detector 834 detects a presence or absence of the dry toner inside the toner reserve tank 83.

The toner detector 834 is provided at a position closer to a toner receiving unit 832 than a toner discharge unit 833. As the toner detector 834, known techniques such as a magnetic sensor, a piezoelectric sensor, and a photoelectric sensor are used.

As shown in FIG. 5, the toner reserve tank 83 is provided with the toner receiving unit 832 that receives the dry toner discharged from the toner discharge unit 813 of the toner cartridge 81.

The toner reserve tank 83 is provided with the toner discharge unit 833 that discharges the dry toner conveyed by the toner conveying member 831.

The dry toner discharged from the toner discharge unit 833 is supplied to the toner conveying unit 84. Specifically, the dry toner discharged from the toner discharge unit 833 is supplied to a toner merging unit 841 (see FIG. 4) provided in the toner conveying unit 84.

The toner receiving unit 832 illustrated in FIG. 5 is provided at a position facing the toner discharge unit 813 of the toner cartridge 81.

The toner receiving unit 832 is provided in the rear side of the toner reserve tank 83. The toner receiving unit 832 is provided on an upper side surface of the toner reserve tank 83.

On the other hand, the toner discharge unit 833 is provided in the front side of the toner reserve tank 83. The toner discharge unit 833 is provided on the lower side surface of the toner reserve tank 83.

The toner discharge unit 833 discharges the dry toner to the toner merging unit 841 (see FIG. 4).

As shown in FIG. 2, the toner conveying unit 84 is provided with the toner merging unit 841 where the dry toners discharged from the two toner reserve tanks 83 merge, and a toner conveying path 842 that conveys the dry toners passing through the toner merging unit 841 toward the toner charging unit 85.

The toner conveying path 842 extends in the front-rear direction of the developer replenishing device 70. The toner conveying path 842 has the cylindrical shape. As shown in FIG. 6, a toner conveying member 843 for conveying the dry toner while stirring the dry toner is provided inside the toner conveying path 842.

The toner conveying member 843 is rotationally driven by the drive motor (not shown), and stirs the dry toner inside the toner conveying path 842. The toner conveying member 843 conveys the dry toner from the front side to the rear side of the toner conveying path 842.

In the present exemplary embodiment, the conveyance direction of the dry toner in the toner conveying unit 84 is along the attachment and detachment direction when the toner cartridge 81 (see FIG. 2) is attached to or detached from the developer replenishing device 70.

The toner charging unit 85 shown in FIG. 6 charges the dry toner conveyed through the toner conveying path 842 into the developing device 14 (see FIG. 1).

In the present exemplary embodiment, the toner charging unit 85 is located vertically above the developing device 14. The toner charging unit 85 causes the dry toner fall downward by gravity, and supplies the dry toner to the developing device 14.

As shown in FIG. 2, the carrier cartridge 91 is disposed so as to extend in the front-rear direction of the developer replenishing device 70. The carrier cartridge 91 has the cylindrical shape.

The carrier cartridge 91 is attachable to and detachable from the device body of the developer replenishing device 70 in the front-rear direction of the developer replenishing device 70.

Specifically, the carrier cartridge 91 is removed from the developer replenishing device 70 by being pulled out to the front side of the developer replenishing device 70. Further, the carrier cartridge 91 is attached to the developer replenishing device 70 by pushing the carrier cartridge 91 to the rear side of the developer replenishing device 70.

In the present exemplary embodiment, a length of the carrier cartridge 91 in the attachment and detachment of the carrier cartridge 91 is shorter than a length of the toner cartridge 81 in the attachment and detachment of the toner cartridge 81.

In other words, in the present exemplary embodiment, a length of the carrier accommodating unit 530 is shorter than a length of the toner accommodating unit 630 when comparing the lengths in the mounting direction of the toner cartridge 81, which is the example of the accommodating container.

In the present exemplary embodiment, a portion on which the carrier cartridge 91 is mounted is the carrier accommodating unit 530 that accommodates the dry carrier.

In the present exemplary embodiment, a new dry carrier is supplied to the carrier accommodating unit 530 by mounting the carrier cartridge 91 to the carrier accommodating unit 530.

Further, in the present exemplary embodiment, a portion on which the toner cartridge 81 is mounted is the toner accommodating unit 630 that accommodates the dry toner.

In the present exemplary embodiment, the new dry toner is supplied to the toner accommodating unit 630 by mounting the toner cartridge 81 on the toner accommodating unit 630.

In the present exemplary embodiment, the length of the carrier accommodating unit 530 is shorter than the length of the toner accommodating unit 630 when comparing the lengths in the mounting direction of the toner cartridge 81.

Further, in the present exemplary embodiment, as shown in FIG. 3, an end portion in the rear side (hereinafter, may be referred to as “rear end”) of the carrier cartridge 91 is located in the front side of the developer replenishing device 70 with respect to an rear end of the toner cartridge 81.

As shown in FIG. 6, a carrier stirring member 911 that stirs the dry carrier is provided inside the carrier cartridge 91.

The carrier stirring member 911 is rotationally driven by the drive motor (not shown).

The carrier stirring member 911 stirs the dry carrier inside the carrier cartridge 91. In addition, the carrier stirring member 911 conveys the dry carrier from a front side to a rear side of the carrier cartridge 91.

In the present exemplary embodiment, a conveyance direction of the dry carrier inside the carrier cartridge 91 is along the attachment and detachment direction when attaching and detaching the carrier cartridge 91.

The carrier cartridge 91 includes a carrier discharge unit 913.

The dry carrier discharged from the carrier discharge unit 913 is supplied to the carrier dispenser 92. Specifically, the dry carrier discharged from the carrier discharge unit 913 is supplied to a carrier reserve tank 93 provided in the carrier dispenser 92. The carrier discharge unit 913 is provided on an outer circumferential surface of the carrier cartridge 91. The carrier discharge unit 913 is provided on a surface of the rear side and a lower side of the carrier cartridge 91.

The carrier dispenser 92 is provided with the carrier reserve tank 93 that accommodates the dry carrier received from the carrier cartridge 91.

Further, the carrier dispenser 92 is provided with a carrier charging unit 95 that charges the dry carrier accommodated in the carrier reserve tank 93 to the developing device 14.

As shown in FIG. 2, the carrier reserve tank 93 is disposed so as to extend in the front-rear direction of the developer replenishing device 70. The carrier reserve tank 93 is formed in a long shape and has a cylindrical shape.

As shown in FIG. 4, the carrier reserve tank 93 is provided vertically below the carrier cartridge 91.

In the present exemplary embodiment, a volume of the carrier reserve tank 93 is smaller than a volume of the toner reserve tank 83.

In the present exemplary embodiment, a cross-sectional area of the carrier reserve tank 93 is smaller than a cross-sectional area of the toner reserve tank 83.

More specifically, the cross-sectional area of the carrier reserve tank 93 is smaller than the cross-sectional area of the toner reserve tank 83 when comparing cross-sectional areas of the surface perpendicular to the mounting direction of the toner cartridge 81.

As shown in FIG. 6, a carrier conveying member 931 for conveying the dry carrier while stirring the dry carrier is provided inside the carrier reserve tank 93.

The carrier conveying member 931 is rotationally driven by the drive motor (not shown).

The carrier conveying member 931 stirs the dry carrier inside the carrier reserve tank 93. The carrier conveying member 931 conveys the dry carrier from a front side to a rear side of the carrier reserve tank 93.

In the present exemplary embodiment, a conveyance direction of the dry carrier in the carrier reserve tank 93 is aligned with a conveyance direction of the dry carrier in the carrier cartridge 91. In other words, the conveyance direction of the dry carrier in the carrier reserve tank 93 coincides with the conveyance direction of the dry carrier in the carrier cartridge 91.

Further, in the present exemplary embodiment, the conveyance direction of the dry carrier in the carrier cartridge 91 and the conveyance direction of the dry carrier in the carrier reserve tank 93 are along the attachment and detachment when the carrier cartridge 91 is attached to or detached from the developer replenishing device 70.

As the carrier conveying member 931, for example, the conveying member including a rotation shaft extending in the front-rear direction of the carrier reserve tank 93 and a blade portion spirally formed around the rotation shaft is exemplified.

A carrier detector 934 is provided inside the carrier reserve tank 93. The carrier detector 934 detects a presence or absence of the dry carrier in the carrier reserve tank 93.

The carrier detector 934 is provided at a position closer to a carrier receiving unit 932 than the carrier charging unit 95. As the carrier detector 934, the known techniques such as the magnetic sensor, the piezoelectric sensor, and the photoelectric sensor are used.

A conveying amount of the dry carrier by the carrier conveying member 931 is smaller than a conveying amount of the dry toner by the toner conveying member 831 provided in the toner reserve tank 83 (see FIG. 5).

As a method for reducing the conveying amount by the carrier conveying member 931 to be smaller than the conveying amount by the toner conveying member 831, a method in which diameters of blade portions are made different is exemplified.

Specifically, for example, a method of making a diameter of the blade portion provided in the carrier conveying member 931 smaller than a diameter of the blade portion provided in the toner conveying member 831 is exemplified.

In addition, as the method for reducing the conveying amount by the carrier conveying member 931 to be smaller than the conveying amount by the toner conveying member 831, a method in which installation intervals of the blade portions are made different is exemplified.

Specifically, for example, a method of making an installation interval of the blade portion provided in the carrier conveying member 931 smaller than an installation interval of the blade portion provided in the toner conveying member 831 is exemplified.

As shown in FIG. 6, the carrier reserve tank 93 is provided with the carrier receiving unit 932 that receives the dry carrier discharged from the carrier cartridge 91.

The carrier receiving unit 932 is provided at a position facing the carrier discharge unit 913 provided in the carrier cartridge 91. The carrier receiving unit 932 is provided in the front side of the carrier reserve tank 93. The carrier receiving unit 932 is provided on an upper side surface of the carrier reserve tank 93.

The carrier charging unit 95 charges the dry carrier in the carrier reserve tank 93 to the developing device 14 (see FIG. 1). In the present exemplary embodiment, the carrier charging unit 95 is located vertically above the developing device 14.

In the present exemplary embodiment, the carrier charging unit 95 is located vertically above the toner charging unit 85 of the toner dispenser 82.

The carrier charging unit 95 causes the dry carrier fall downward by the gravity, and charges the dry carrier to the developing device 14. More specifically, the carrier charging unit 95 charges the dry carrier into the developing device 14 by causing the dry carrier fall from vertically above the toner charging unit 85.

(Operation of Developer Replenishing Device 70)

An operation of the developer replenishing device 70 will be described.

As the dry toner and the dry carrier in the developing device 14 decrease, the developer replenishing device 70 replenishes the new dry toner and the new dry carrier to the developing device 14.

In the developing device 14, the dry toner is consumed in accordance with a formation of the toner image on the photosensitive drum 11, and the dry toner is reduced.

In addition, in the developing device 14, the developer including the dry carrier having a reduced charging performance is discharged. By this discharge, the dry toner and the dry carrier decrease.

Normally, in the developing device 14, an amount of reduction per unit time of the dry carrier is smaller than an amount of reduction per unit time of the dry toner.

In the present exemplary embodiment, for example, when a concentration of the dry toner in the developing device 14 falls below a predetermined reference value, the developer replenishing device 70 supplies the dry toner to the developing device 14.

Specifically, the developer replenishing device 70 rotationally drives the toner stirring member 811 of the toner cartridge 81, the toner conveying member 831 of the toner reserve tank 83, and the toner conveying member 843 of the toner conveying path 842 to supply the dry toner to the developing device 14.

When the dry toner is supplied, the dry toner is conveyed from the front side to the rear side of the toner cartridge 81 by the toner stirring member 811, and the dry toner flows into the toner reserve tank 83 of the toner dispenser 82.

In the toner reserve tank 83, the dry toner is conveyed from the rear side to the front side of the toner reserve tank 83 by the toner conveying member 831. As a result, the dry toner flows into the toner conveying unit 84.

In the toner conveying unit 84, the dry toner is conveyed from the front side to the rear side by the toner conveying member 843. As a result, the dry toner flows into the toner charging unit 85.

Then, the dry toner falls from the toner charging unit 85 to the developing device 14, and the dry toner is supplied to the developing device 14.

In the present exemplary embodiment, when an amount of the dry toner inside the toner cartridge 81 falls below the predetermined reference value, the toner cartridge 81 is replaced with a new toner cartridge 81.

In other words, in the present exemplary embodiment, when the toner cartridge 81 is empty, the toner cartridge 81 is replaced with the new toner cartridge 81.

In the present exemplary embodiment, the toner reserve tank 83 accommodates the dry toner received from the toner cartridge 81. In other words, the toner reserve tank 83 stores the dry toner received from the toner cartridge 81.

In this case, even when the toner cartridge 81 is removed for replacement of the toner cartridge 81, the dry toner accommodated in the toner reserve tank 83 may be used to continuously supply the dry toner to the developing device 14.

In the developing device 14, the amount of reduction in the dry toner is larger than the amount of reduction in the dry carrier. Correspondingly, even in the developer replenishing device 70, the amount of reduction in the dry toner is larger than the amount of reduction in the dry carrier.

Correspondingly, in the developer replenishing device 70 of the present exemplary embodiment, two toner cartridges 81 and two toner reserve tanks 83 are provided, respectively.

As a result, for example, even when one of the toner cartridges 81 or the toner reserve tanks 83 is empty, the other toner cartridge 81 or the toner reserve tank 83 may be used to continuously supply the dry toner to the developing device 14.

In the present exemplary embodiment, as described above, the conveyance direction of the dry toner in the toner cartridge 81 is opposite to the conveyance direction of the dry toner in the toner reserve tank 83.

In this case, a size of the developer replenishing device 70 may be reduced as compared with a case where the conveyance direction of the dry toner in the toner cartridge 81 and the conveyance direction of the dry toner in the toner reserve tank 83 are the same.

In the present exemplary embodiment, capacities of the toner cartridge 81 and the toner reserve tank 83 may be increased as compared with the case where the conveyance direction of the dry toner in the toner cartridge 81 and the conveyance direction of the dry toner in the toner reserve tank 83 are the same.

When the capacity is increased in this manner, a replacement frequency of the toner cartridge 81 may be reduced. In addition, it is difficult for the supply of the dry toner to the developing device 14 to be interrupted.

When replacing the toner cartridge 81 with the new toner cartridge 81, if the toner reserve tank 83 is empty, there is a time lag between time when the new toner cartridge 81 is mounted and time when the dry toner is supplied to the developing device 14.

In the present exemplary embodiment, an operation of conveying the dry toner is performed in the toner cartridge 81 and the toner reserve tank 83 between the time when the new toner cartridge 81 is mounted and time when the toner detector 834 (see FIG. 5) detects the dry toner.

This operation may be performed before the image forming apparatus 100 receives a print instruction from the user.

Here, in the present exemplary embodiment, as shown in FIG. 5, the toner detector 834 is provided at a position closer to the toner receiving unit 832 than the toner discharge unit 833.

In this case, it is possible to more accurately detect whether the toner cartridge 81 is empty.

On the other hand, when an amount of the dry carrier in the developing device 14 falls below the predetermined reference value, the developer replenishing device 70 supplies the dry carrier to the developing device 14.

Specifically, the developer replenishing device 70 rotationally drives the carrier stirring member 911 and the carrier conveying member 931.

As a result, the dry carrier is conveyed from the front side to the rear side of the carrier cartridge 91, and the dry carrier flows into the carrier reserve tank 93. In the carrier reserve tank 93, the dry carrier is conveyed from the front side to the rear side of the carrier reserve tank 93. As a result, the dry carrier flows into the carrier charging unit 95.

Then, the dry carrier falls from the carrier charging unit 95 to the developing device 14, and the dry carrier is supplied to the developing device 14.

Further, in the developer replenishing device 70, when the amount of the dry carrier accommodated in the carrier cartridge 91 falls below the predetermined reference value, the carrier cartridge 91 is replaced with a new carrier cartridge 91.

In other words, when the carrier cartridge 91 is empty, the carrier cartridge 91 is replaced with the new carrier cartridge 91.

In the present exemplary embodiment, the carrier reserve tank 93 accommodates the dry carrier received from the carrier cartridge 91. In other words, the carrier reserve tank 93 stores the dry carrier received from the carrier cartridge 91.

Therefore, for example, even when the carrier cartridge 91 is removed for replacement of the carrier cartridge 91, the dry carrier may be continuously supplied to the developing device 14.

When the carrier cartridge 91 is replaced with the new carrier cartridge 91, in a case where the carrier reserve tank 93 is empty, there is the time lag between time when the new carrier cartridge 91 is mounted and time when the dry carrier is supplied to the developing device 14.

When the new carrier cartridge 91 is mounted, an operation of conveying the dry carrier is performed inside the carrier cartridge 91 and the carrier reserve tank 93 until the carrier detector 934 (see FIG. 6) detects the dry carrier.

This operation may be performed before the image forming apparatus 100 receives the print instruction from the user.

In the present exemplary embodiment, the carrier detector 934 is provided at the position closer to the carrier receiving unit 932 than the carrier charging unit 95.

Therefore, in the present exemplary embodiment, it is possible to accurately detect whether the carrier cartridge 91 is empty.

In the present exemplary embodiment, the volume of the carrier reserve tank 93 is smaller than the volume of the toner reserve tank 83.

In the present exemplary embodiment, the amount of reduction in the dry carrier in the developer replenishing device 70 is smaller than the amount of reduction in the dry toner in the developer replenishing device 70.

Therefore, even when the volume of the carrier reserve tank 93 is made smaller than the volume of the toner reserve tank 83 as in the present exemplary embodiment, problems such as interruption of the supply of the dry carrier to the developing device 14 are unlikely to occur.

Further, as in the present exemplary embodiment, when the volume of the carrier reserve tank 93 is made smaller than the volume of the toner reserve tank 83, a volume of the carrier dispenser 92 may be reduced. As a result, a size of the developer replenishing device 70 may be reduced.

Further, in the present exemplary embodiment, a length of the carrier reserve tank 93 is shorter than a length of the toner reserve tank 83. More specifically, the length of the carrier reserve tank 93 is shorter than the length of the toner reserve tank 83 when comparing the lengths in the attachment and detachment direction of the toner cartridge 81.

In this case, a conveyance distance of the dry carrier in the carrier reserve tank 93 is shorter than that in a case where the length of the carrier reserve tank 93 is equal to or longer than the length of the toner reserve tank 83.

In this case, the volume of the carrier dispenser 92 is smaller than that in the case where the length of the carrier reserve tank 93 is equal to or longer than the length of the toner reserve tank 83.

In the present exemplary embodiment, the conveying amount of the dry carrier by the carrier conveying member 931 provided in the carrier reserve tank 93 is smaller than the conveying amount of the dry toner by the toner conveying member 831 provided in the toner reserve tank 83.

In the present exemplary embodiment, a supply amount of the dry carrier to the developing device 14 is smaller than a supply amount of the dry toner to the developing device 14.

Therefore, even when the conveying amount of the dry carrier by the carrier conveying member 931 provided in the carrier reserve tank 93 is smaller than the conveying amount of the dry toner by the toner conveying member 831 provided in the toner reserve tank 83, it is unlikely that the supply of the dry carrier to the developing device 14 is delayed.

When the conveying amount of the dry carrier by the carrier conveying member 931 provided in the carrier reserve tank 93 is smaller than the conveying amount of the dry toner by the toner conveying member 831 provided in the toner reserve tank 83, the diameter of the blade portion of the carrier conveying member 931 may be made small.

In this case, the size of the carrier conveying member 931 may be reduced, and accordingly, the size of the developer replenishing device 70 may be reduced.

In the present exemplary embodiment, as described above, the conveyance direction of the dry carrier in the carrier cartridge 91 is aligned with the conveyance direction of the dry carrier in the carrier reserve tank 93.

As a result, for example, the conveyance distance of the dry carrier in the carrier reserve tank 93 may be shortened as compared with a case where the conveyance direction of the dry carrier in the carrier cartridge 91 and the conveyance direction of the dry carrier in the carrier reserve tank 93 are opposite to each other.

Further, in the present exemplary embodiment, the length of the carrier cartridge 91 in the attachment and detachment is shorter than the length of the toner cartridge 81 in the attachment and detachment.

As shown in FIG. 3, the rear end of the carrier cartridge 91 is located in the front side of the developer replenishing device 70 as compared with the rear end of the toner cartridge 81.

As a result, in the present exemplary embodiment, the carrier dispenser 92 may be provided in a difference region between the lengths of the carrier cartridge 91 and the toner cartridge 81, and the size of the developer replenishing device 70 may be reduced.

In other words, as shown in FIG. 3, the carrier dispenser 92 may be provided in the rear side of the carrier cartridge 91, and the size of the developer replenishing device 70 may be reduced.

Further, in general, the dry carrier has a higher specific density than the dry toner. When the length of the carrier cartridge 91 accommodating the dry carrier having a large specific density along the attachment and detachment is made shorter than the length of the toner cartridge 81 accommodating the dry toner having a small specific density along the attachment and detachment, operability in attaching and detaching the carrier cartridge 91 is improved.

Specifically, the length in which the user moves the carrier cartridge 91 in the attachment and detachment may be smaller than the length in which the user moves the toner cartridge 81 in the attachment and detachment, and the operability in attaching and detaching the carrier cartridge 91 is improved.

In the developer replenishing device 70 of the present exemplary embodiment, as shown in FIG. 3, the carrier cartridge 91 is located vertically below the toner cartridge 81.

Specifically, the lowermost portion of the carrier cartridge 91 in a vertical direction is located vertically below the lowermost portion of the toner cartridge 81 in the vertical direction.

In other words, the lowermost portion of the carrier accommodating unit 530 in the vertical direction is located vertically below the lowermost portion of the toner accommodating unit 630 in the vertical direction.

Further, in the present exemplary embodiment, a central axis of the carrier cartridge 91 is located vertically below a central axis of the toner cartridge 81.

In the present exemplary embodiment, the uppermost portion of the carrier cartridge 91 in the vertical direction is located vertically below the uppermost portion of the toner cartridge 81 in the vertical direction.

As described above, in the present exemplary embodiment, the carrier cartridge 91 accommodating the dry carrier having the large specific density is located vertically below the toner cartridge 81 accommodating the dry toner having the small specific density.

In this case, the user may attach and detach the carrier cartridge 91 vertically below a position where the toner cartridge 81 is attached and detached.

In the present exemplary embodiment, the carrier charging unit 95 (see FIG. 6) charges the dry carrier into the developing device 14 by causing the dry carrier to fall from vertically above the toner charging unit 85.

As described above, when the dry carrier having the large specific density is charged vertically above the dry toner having the small specific density, the dry carrier falling from above in the vertical direction is brought into contact with the dry toner in the toner charging unit 85.

As a result, the dry toner in the toner charging unit 85 is broken, and clogging of the dry toner is prevented. In addition, the dry toner and the dry carrier are easily mixed with each other, and unevenness in the concentration of the dry toner in the developing device 14 is reduced.

In the present exemplary embodiment, the dry toner is directly supplied from the toner charging unit 85 to the developing device 14, and the dry carrier is directly supplied from the carrier charging unit 95 to the developing device 14, but the present disclosure is not limited to this.

For example, the dry toner may be supplied from the toner charging unit 85 to a common conveying path leading to the developing device 14, and the dry carrier may be supplied from the carrier charging unit 95.

In this case, the dry toner and the dry carrier travel toward the developing device 14 through the common conveying path.

In this case, the toner charging unit 85 may be provided on the upstream side and the carrier charging unit 95 may be provided on the downstream side in the conveyance direction in the conveying path. In this case, the dry carrier from the carrier charging unit 95 may be supplied to the conveying path from above the conveying path.

In the above description, it is described that the toner cartridge 81 is removed by pulling out the toner cartridge 81 toward the front side of the developer replenishing device 70, and the toner cartridge 81 is mounted by pushing the toner cartridge 81 toward the rear side of the developer replenishing device 70.

However, the present disclosure is not limited thereto, and the toner cartridge 81 may be removed from the developer replenishing device 70 by being pulled out toward the rear side of the developer replenishing device 70, and may be mounted on the developer replenishing device 70 by being pushed toward the front side of the developer replenishing device 70.

In the above description, it is described that the carrier cartridge 91 is removed by pulling out the carrier cartridge 91 toward the front side of the developer replenishing device 70, and the carrier cartridge 91 is mounted by pushing the carrier cartridge 91 toward the rear side of the developer replenishing device 70.

However, the present disclosure is not limited thereto, and the carrier cartridge 91 may be removed from the developer replenishing device 70 by being pulled out toward the rear side of the developer replenishing device 70, and may be mounted on the developer replenishing device 70 by being pushed toward the front side of the developer replenishing device 70.

In the present exemplary embodiment, as described above, the toner stirring member 811 (see FIG. 5) used for conveying the dry toner is provided inside the toner cartridge 81, but the toner stirring member 811 may not be necessary.

The dry toner may be conveyed by providing a spiral protrusion on an inner circumferential surface of the toner cartridge 81 and rotationally driving the toner cartridge 81 in the circumferential direction.

Similarly, with respect to the carrier cartridge 91, the dry carrier may be conveyed by providing the spiral protrusion on the inner circumferential surface of the carrier cartridge 91 and rotationally driving the carrier cartridge 91 in the circumferential direction.

In the above description, it is described that the toner detector 834 (see FIG. 5) is provided at the position closer to the toner receiving unit 832 than the toner discharge unit 833.

However, the present disclosure is not limited thereto, and the toner detector 834 may be provided at a position closer to the toner discharge unit 833 than the toner receiving unit 832. In this case, it is easy to supply the dry toner to the position close to the toner discharge unit 833 of the toner reserve tank 83.

In the above description, it is described that the carrier detector 934 (see FIG. 6) is provided at the position closer to the carrier receiving unit 932 than the carrier charging unit 95.

However, the present disclosure is not limited thereto, and the carrier detector 934 may be provided at a position closer to the carrier charging unit 95 than the carrier receiving unit 932. In this case, it is easy to supply the dry carrier to the position close to the carrier charging unit 95 of the carrier reserve tank 93.

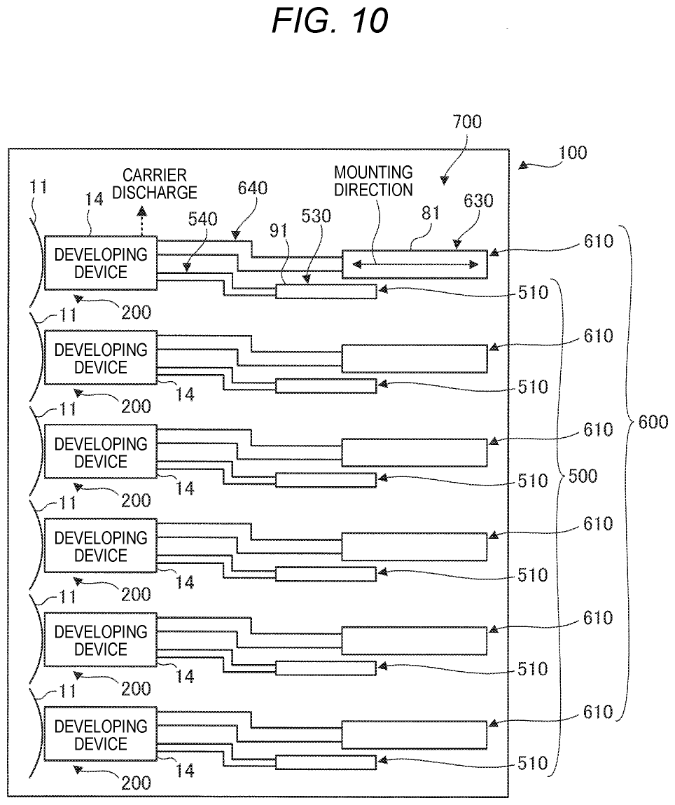

FIG. 10 is a schematic diagram illustrating functions of the image forming apparatus 100 illustrated in FIG. 1.

In FIG. 10, the image forming unit 200 and the developer replenishing device 70 are displayed, and illustration of other elements is omitted.

In the image forming apparatus 100 according to the present exemplary embodiment, as illustrated in FIG. 10, a carrier supply mechanism 500 configured to supply the dry carrier to plural developing devices 14 is provided.

Further, in the present exemplary embodiment, a toner supply mechanism 600 configured to supply the dry toner to the plural developing devices 14 is provided.

In the present exemplary embodiment, the carrier supply mechanism 500 and the toner supply mechanism 600 are implemented by the plural developer replenishing devices 70.

In the present exemplary embodiment, the carrier supply mechanism 500 is provided with six carrier supply units 510 provided corresponding to the respective developing devices 14. In other words, the carrier supply mechanism 500 is provided with the six carrier supply units 510 provided corresponding to the respective image forming units 200.

Further, the toner supply mechanism 600 is provided with six toner supply units 610 provided corresponding to the respective developing devices 14. In other words, the toner supply mechanism 600 is provided with the six toner supply units 610 provided corresponding to the respective image forming units 200.

Each of the toner supply units 610 is provided with the toner accommodating unit 630 and a toner replenishing unit 640.

In the present exemplary embodiment, the toner accommodating unit 630 is provided at the position different from the developing device 14.

In the present exemplary embodiment, the dry toner newly supplied from the outside of the image forming apparatus 100 is accommodated in the toner accommodating unit 630. In the present exemplary embodiment, the new dry toner is supplied from the toner accommodating unit 630 to the corresponding developing device 14.

More specifically, in the present exemplary embodiment, the toner replenishing unit 640 receives the dry toner from the toner accommodating unit 630 and supplies the dry toner to the corresponding developing device 14.

Each of the carrier replenishing units 510 is provided with the carrier accommodating unit 530 and a carrier replenishing unit 540.

In the present exemplary embodiment, the carrier accommodating unit 530 is provided at the position different from the developing device 14.

In the present exemplary embodiment, the dry carrier newly supplied from the outside of the image forming apparatus 100 is accommodated in the carrier accommodating unit 530. In the present exemplary embodiment, the new dry carrier is supplied from the carrier accommodating unit 530 to the corresponding developing device 14.

More specifically, in the present exemplary embodiment, the carrier replenishing unit 540 receives the dry carrier from the carrier accommodating unit 530 and supplies the dry carrier to the corresponding developing device 14.

In the present exemplary embodiment, a length of the carrier replenishing unit 540 is shorter than a length of the toner replenishing unit 640.

More specifically, the length of the carrier replenishing unit 540 in the mounting direction is shorter than the length of the toner s replenishing unit 640 in the mounting direction when comparing the lengths in the mounting direction of the toner cartridge 81.

More specifically, a sum of the lengths of the portions of the carrier replenishing unit 540 along the mounting direction is shorter than a sum of the lengths of the portions of the toner replenishing unit 640 along the mounting direction.

In the exemplary embodiment, the cross-sectional area of the portion of the carrier replenishing unit 540 that extends in the mounting direction is smaller than the cross-sectional area of the portion of the toner replenishing unit 640 that extends in the mounting direction when comparing the cross-sectional areas perpendicular to the mounting direction of the toner cartridge 81.

In the present exemplary embodiment, the length of the carrier accommodating unit 530 is shorter than the length of the toner accommodating unit 630 when comparing the lengths in the mounting direction of the toner cartridge 81.

Further, in the present exemplary embodiment, the volume of a space of a portion of the carrier supply mechanism 500 through which the dry carrier passes is smaller than the volume of a space of a portion of the toner supply mechanism 600 through which the dry toner passes.

The “volume of the space of the portion of the carrier supply mechanism 500 through which the dry carrier passes” refers to a volume obtained by adding (summing) volumes of portions of the carrier supply unit 510 provided for each of the developing devices 14 through which the dry carrier passes.

The “volume of the space of the portion of the toner supply mechanism 600 through which the dry toner passes” refers to a volume obtained by adding (summing) the volumes of the portions of the toner supply unit 610 provided for each of the developing devices 14 through which the dry carrier passes.

Here, the “volume of the portion of the carrier supply unit 510 through which the dry carrier passes” includes not only the volume of the carrier replenishing unit 540 but also the volume of the carrier accommodating unit 530, and the “portion of the carrier supply unit 510 through which the dry carrier passes” indicates a portion from the carrier accommodating unit 530 to the developing device 14.

In addition, the “volume of the portion of the toner supply unit 610 through which the dry toner passes” includes not only the volume of the toner replenishing unit 640 but also the volume of the toner accommodating unit 630, and the “portion of the toner supply unit 610 through which the dry carrier passes” indicates a portion from the toner accommodating unit 630 to the developing device 14.

The “volume of the portion of the carrier supply unit 510 through which the dry carrier passes” includes not only the volume of the portion actually occupied by the dry carrier but also the volume of the space located above the dry carrier and where the dry carrier does not exist.

The “volume of the portion of the toner supply unit 610 through which the dry toner passes” includes not only the volume of the portion actually occupied by the dry carrier but also the volume of the space located above the dry carrier and where the dry carrier does not exist.

In addition, the “volume of the portion of the carrier supply unit 510 through which the dry carrier passes” indicates a volume in a case where it is assumed that a member used for conveying the dry carrier is not provided, such as the carrier stirring member 911 and the carrier conveying member 931 illustrated in FIG. 6.

In addition, the “volume of the portion of the toner supply unit 610 through which the dry toner passes” indicates a volume in a case where it is assumed that a member used for conveying the dry toner is not provided, such as the toner stirring member 811, the toner conveying member 831 and the toner conveying member 843 illustrated in FIGS. 5 and 6.

Further, in the present exemplary embodiment, a value obtained by adding a supply amount of the dry carrier to the developing device 14 and a discharge amount of the dry carrier from the developing device 14 is smaller than a consumption amount of the dry toner consumed when the toner image is formed in the image forming unit 200.

Here, a carrier supply amount, which is the supply amount of the carrier per unit time when the dry carrier is supplied to each developing device 14, is assumed.

Further, a carrier discharge amount, which is the discharge amount of the carrier per unit time when the dry carrier is discharged from each developing device 14, is assumed.

Further, a toner consumption amount, which is the amount of the dry toner consumed per unit time when the toner image is formed in each image forming unit 200, is assumed.

In the present exemplary embodiment, a value obtained by multiplying the sum of the carrier supply amount and the carrier discharge amount by the number of the image forming units 200 that are provided (“6” in the present exemplary embodiment) is smaller than a value obtained by multiplying the toner consumption amount by the number of the image forming units that are provided.

With such a relationship, the volume occupied by the carrier supply mechanism 500 may be reduced and the size of the image forming apparatus 100 may be reduced, as compared with a case where such a relationship is not satisfied.

In other words, in the present exemplary embodiment, the value obtained by adding the carrier supply amount and the carrier discharge amount is smaller than the amount of the dry toner supplied to the outside of the developing device 14 through the opening 143 (see FIG. 8).

Further, a supplied toner amount, which is the amount of the dry toner supplied to the outside of the developing device 14 per unit time, through the opening 143, when the toner image is formed in the image forming unit 200, is assumed.

In the present exemplary embodiment, the value obtained by multiplying the sum of the carrier supply amount and the carrier discharge amount by the number of the image forming units 200 that are provided is smaller than a value obtained by multiplying the supplied toner amount by the number of the image forming units that are provided.

With such a relationship, as described above, the volume occupied by the carrier supply mechanism 500 may be reduced and the size of the image forming apparatus 100 may be reduced.

Further, the amount of the dry toner consumed when the image is formed on a sheet of A3 size and the amount of the dry toner consumed when the image is formed on a sheet of A3 size or more are compared with each other.

For example, the amount of the dry toner consumed when the image is formed on an entire surface of the sheet of A3 size with 100% image density and the amount of the dry toner consumed when the image is formed on the entire surface of the sheet of A3 size or more with the 100% image density are compared with each other. Specifically, a comparison is made in a case of the A2 size, an A1 size, an A0 size, a B3 size, a B2 size, a B1 size, and a B0 size.

Since a length 1 of a short side, the length L of the long side, and an area M of each sheet are the A2 size (l=420 mm, L=594 mm, M=249,480 mm²), the A1 size (1=594 mm, L=841 mm, M=449,554 mm²), the A0 size (l=841 mm, L=1,189 mm, M=999,949 mm²), the B3 size (l=364 mm, L=515 mm, M=187,460 mm²), the B2 size (l=515 mm, L=728 mm, M=374,920 mm²), the B1 size (l=728 mm, L=1,030 mm, M=749,840 mm²), the B0 size (l=1,030 mm, L=1,456 mm, M=1,499,680 mm²), when the amount of the dry toner consumed in the A3 size is 1, the A2 size is 2 times, the A1 size is 4 times, the A0 size is 8 times, the B3 size is 1.5 times, the B2 size is 3 times, the B1 size is 6 times, the B0 size is 12 times the consumption amount of the dry toner. The same applies to the supply amount of the dry toner supplied to the developing device 14, when the supply amount in the A3 size is 1, the supply amounts in the A2 size, the A1 size, the A0 size, the B3 size, the B2 size, the B1 size, and the B0 size are 2 times, 4 times, 8 times, 1.5 times, 3 times, 6 times, 12 times the supply amount of the dry toner.

In addition, as the consumption amount of the dry toner increases, the consumption amount of the dry carrier increases.

As in the present exemplary embodiment, when the length L of the developing sleeve 145A in the axial direction is equal to or longer than the length of the long side of the A3 size, if the volume occupied by the carrier supply mechanism 500 may be reduced, the size of the image forming apparatus 100 may be reduced. Further, when at least five image forming units 200 are provided, if the volume occupied by the carrier supply mechanism 500 may be reduced, the size of the image forming apparatus 100 may be reduced.

Further, in the present exemplary embodiment, as illustrated in FIG. 10, the toner accommodating unit 630 that accommodates the dry toner newly supplied from the outside of the image forming apparatus 100 is provided at the position different from the developing device 14.

Further, in the present exemplary embodiment, the toner accommodating unit 630 is provided so as to correspond to each of the image forming units 200. In the present exemplary embodiment, the new dry toner is supplied from the toner accommodating unit 630 to the corresponding developing device 14.

In the present exemplary embodiment, the toner replenishing unit 640 is provided so as to correspond to each of the image forming units 200. The toner replenishing unit 640 receives the dry toner from the toner accommodating unit 630 and supplies the dry toner to the corresponding developing device 14.

Further, in the present exemplary embodiment, the carrier accommodating unit 530 that accommodates the dry carrier newly supplied from the outside of the image forming apparatus 100 is provided at the position different from the developing device 14.

In the present exemplary embodiment, the carrier accommodating unit 530 is provided so as to correspond to each of the image forming units 200. In the present exemplary embodiment, the new dry carrier is supplied from the carrier accommodating unit 530 to the corresponding developing device 14.

In the present exemplary embodiment, the carrier replenishing unit 540 is provided so as to correspond to each of the image forming units 200. The carrier replenishing unit 540 receives the dry carrier from the carrier accommodating unit 530 and supplies the dry carrier to the corresponding developing device 14.

FIG. 10 illustrates a case where the new dry toner is supplied to the toner accommodating unit 630 by providing the toner cartridge 81 accommodating the dry toner in the toner accommodating unit 630. In this case, the new dry toner is supplied from the toner cartridge 81 provided in the toner accommodating unit 630 to the developing device 14. As described above, the present disclosure is not limited thereto, and the toner accommodating unit 630 may be configured by the accommodation chamber that accommodates the dry toner. In this case, the new dry toner is supplied from the transfer container to the accommodating chamber, and the dry toner is supplied to the toner accommodating unit 630.

In the present exemplary embodiment, the new dry carrier is supplied to the carrier accommodating unit 530 by providing the carrier cartridge 91, which is the example of the accommodating container that accommodates the dry carrier, in the carrier accommodating unit 530.

The present disclosure is not limited thereto, as described above, the carrier accommodating unit 530 may be configured by the accommodation chamber that accommodates the dry carrier. In this case, the new dry carrier is supplied from the transfer container to the accommodating chamber, and the dry carrier is supplied to the carrier accommodating unit 530.

In the present exemplary embodiment, a sum of the volumes of the plural carrier accommodating units 530 is smaller than a sum of the volumes of the plural toner accommodating units 630.

In other words, a total value obtained by adding the volumes of the plural carrier accommodating units 530 is smaller than a total value obtained by adding the volumes of the plural toner accommodating units 630.

In the present exemplary embodiment, a sum of the volumes of the plural carrier supply units 540 is smaller than a sum of the volumes of the plural toner supply units 640.

In other words, a total value obtained by adding the volumes of the plural carrier supply units 540 is smaller than a total value obtained by adding the volumes of the plural toner supply units 640.

Further, in the present exemplary embodiment, a sum of respective added volumes, which is a total volume of the carrier replenishing unit 540 and the carrier accommodating unit 530, is smaller than a sum of respective added volumes, which is a total volume of the toner replenishing unit 640 and the toner accommodating unit 630.

More specifically, it is assumed that a first sum is the sum of the added volumes, which is the total volume of the carrier replenishing unit 540 and the carrier accommodating unit 530, and is the sum of the added volumes obtained for each carrier supply unit 510.

In addition, it is assumed that a second sum is the sum of the added volumes, which is the total volume of the toner replenishing unit 640 and the toner accommodating unit 630, and is the sum of the added volumes obtained for each toner supply unit 610.

In the present exemplary embodiment, the first sum is smaller than the second sum. Further, in the present exemplary embodiment, when the volume of the carrier replenishing unit 540 alone is compared with the volume of the toner replenishing unit 640 alone, the volume of the carrier replenishing unit 540 is smaller than the volume of the toner replenishing unit 640.

Further, in the present exemplary embodiment, when the volume of the carrier accommodating unit 530 alone is compared with the volume of the toner accommodating unit 630 alone, the volume of the carrier accommodating unit 530 is smaller than the volume of the toner accommodating unit 630.

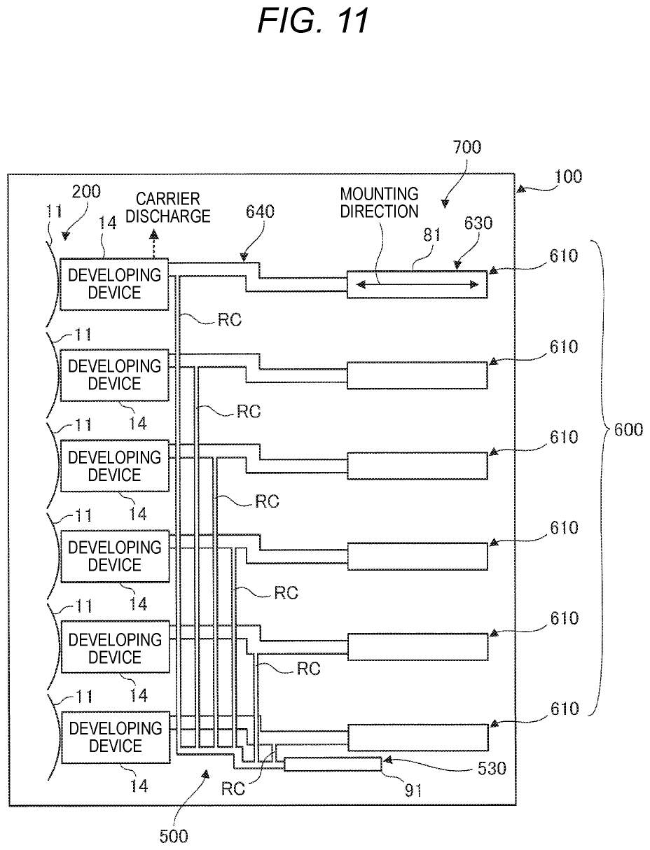

FIG. 11 is a diagram illustrating another configuration example of the image forming apparatus 100.

In this configuration example, plural carrier movement routes RCs extending from the common carrier accommodating unit 530 toward the plural developing devices 14 are provided.

In the present exemplary embodiment, the portion of the carrier supply mechanism 500 through which the dry carrier passes is the carrier movement route RC that is a movement route of the dry carrier.

In this configuration example, the plural carrier movement routes RCs are provided. Further, in this configuration example, the plural carrier movement routes RCs extend from the common carrier accommodating unit 530 to the plural developing devices 14.

More specifically, in this configuration example, the carrier movement route RC is branched from the carrier accommodating unit 530 to the developing device 14, and the plural carrier movement routes RCs are provided by the branching. Each of the plural carrier movement routes RCs is directed toward different developing devices 14.

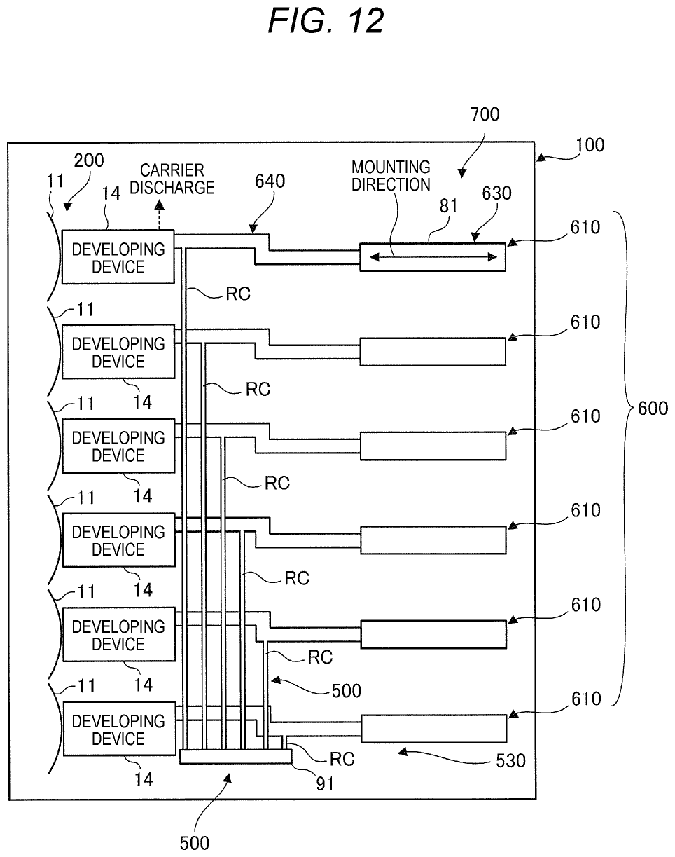

As described above, the carrier movement route RC is not limited to a form of branching from the middle, as shown in FIG. 12 (a diagram illustrating another configuration example of the image forming apparatus 100), each of the carrier movement routes RCs may be provided independently.

In the configuration example illustrated in FIG. 12, each of the independently provided carrier movement routes RCs is connected to the common carrier accommodating unit 530.

In providing the common carrier accommodating unit 530, the number of the carrier accommodating units 530 is not particularly limited. The number of the common carrier accommodating unit 530 is not limited to one, and plural common carrier accommodating units 530 may be provided.

In a case where the common carrier accommodating unit 530 is provided, the number of the carrier accommodating units 530 that are provided may be set to be smaller than the number of the developing devices 14 that are provided.

For example, two carrier accommodating units 530 may be provided, and the carrier movement routes RCs may be directed from each of the two carrier accommodating units 530 to the three developing devices 14.

In this configuration example illustrated in FIGS. 11 and 12, the new dry toner is supplied to the toner accommodating unit 630 by providing the toner cartridge 81 in the toner accommodating unit 630 in the same manner as described above.

In this configuration example, the new dry carrier is supplied to the carrier accommodating unit 530 by providing the carrier cartridge 91 to the carrier accommodating unit 530 in the same manner as described above.

The present disclosure is not limited thereto, and the toner accommodating unit 630 may be configured by the accommodation chamber for accommodating the dry toner in the same manner as described above. In addition, the carrier accommodating unit 530 may also be configured by the accommodation chamber for accommodating the dry carrier.

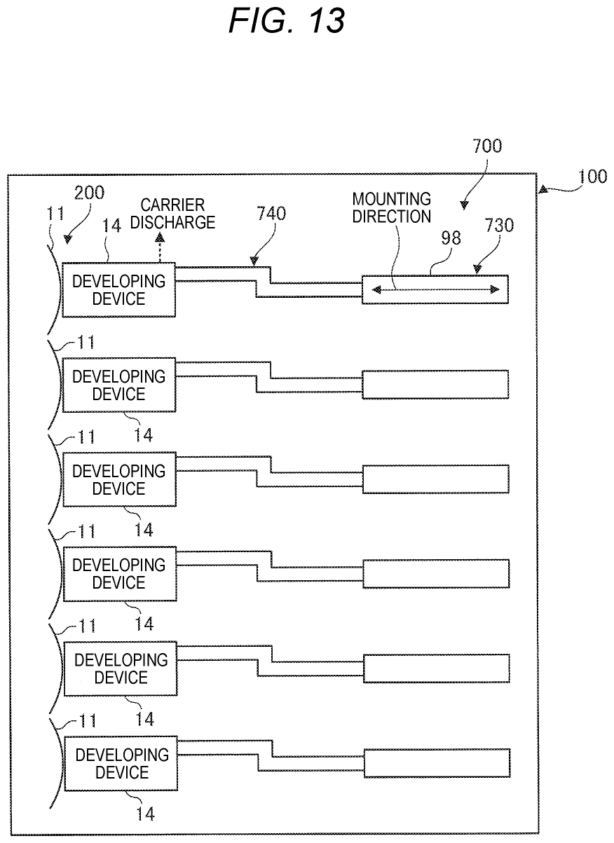

FIG. 13 is a diagram illustrating another configuration example of the image forming apparatus 100.

In this configuration example, a developer accommodating unit 730 is provided corresponding to each of the developing devices 14.

Specifically, in this configuration example, the two accommodating units of the carrier accommodating unit 530 and the toner accommodating unit 630 are not provided.

In this configuration example, one developer accommodating unit 730 is provided corresponding to each of the developing devices 14. Further, one developer replenishing unit 740 is provided corresponding to each of the developing devices 14.

The developer replenishing unit 740 receives the developer from the developer accommodating unit 730 and replenishes the developer to the corresponding developing device 14.

In this configuration example, a developer cartridge 98 that accommodates the developer including the dry toner and the dry carrier is provided in the developer accommodating unit 730. In other words, in this configuration example, the developer cartridge 98 that accommodates a mixture in which the dry toner and the dry carrier are mixed is provided in the developer accommodating unit 730.

Then, the dry toner and the dry carrier are supplied from the developer cartridge 98 to the corresponding developing device 14.

In this configuration example, the type of the dry toner accommodated in the developer cartridge 98 is different for each developer cartridge 98.

The dry carrier is not different for each developer cartridge 98, and a common dry toner is accommodated in each developer cartridge 98.

For each developer cartridge 98, the type of the dry carrier accommodated in the developer cartridge 98 may be different.

In this configuration example, one of a space for providing the carrier accommodating unit 530 and a space for providing the toner accommodating unit 630 is not provided, and the size of the image forming apparatus 100 may be reduced.

In the same manner as described above, the developer accommodating unit 730 is not limited to a form in which the developer cartridge 98 is provided, and may be configured by the accommodating chamber as described above, and only the developer may be supplied to the accommodating chamber.

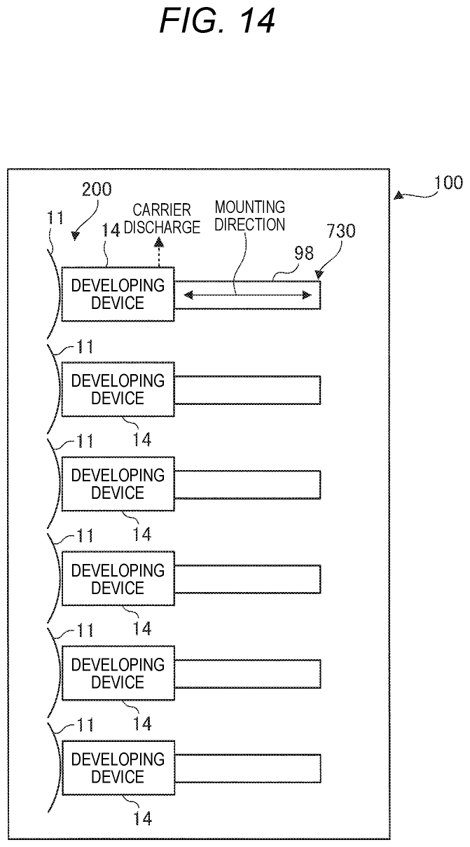

FIG. 14 is a diagram illustrating another configuration example of the image forming apparatus 100.

FIG. 14 shows a modification of the image forming apparatus 100 illustrated in FIG. 13.

In this configuration example illustrated in FIG. 14, the developer replenishing unit 740 illustrated in FIG. 13 is not provided, and the developer accommodating unit 730 is directly connected to the developing device 14.

The developer replenishing unit 740 may not be necessary, and the developer may be directly supplied from the developer accommodating unit 730 to the developing device 14. In this configuration example illustrated in FIG. 14, in the same manner as described above, the developer cartridge 98 may be provided in the developer accommodating unit 730 to supply the developer to the developer accommodating unit 730, or the developer accommodating unit 730 may be used as the accommodating chamber, and only the developer may be supplied to the accommodating chamber.

This direct connection configuration may be applied to the image forming apparatus 100 illustrated in FIGS. 10 and 11.

Specifically, in the image forming apparatus 100 illustrated in FIG. 10, the toner replenishing unit 640 and the carrier replenishing unit 540 may be omitted, the developing device 14 and the toner accommodating unit 630 may be directly connected to each other, and the developing device 14 and the carrier accommodating unit 530 may be directly connected to each other.

In the image forming apparatus 100 illustrated in FIG. 11, the toner replenishing unit 640 may be omitted, and the developing device 14 and the toner accommodating unit 630 may be directly connected to each other.

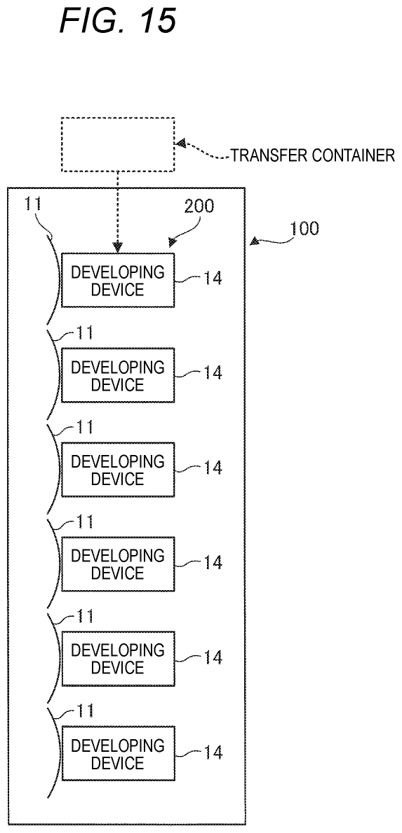

FIG. 15 is a diagram illustrating another configuration example of the image forming apparatus 100.

In this configuration example, the carrier accommodating unit 530, the toner accommodating unit 630, and the developer accommodating unit 730 described above are not provided. In this configuration example, the carrier replenishing unit 540, the toner replenishing unit 640, and the developer replenishing unit 740 described above are not provided.

In this configuration example illustrated in FIG. 15, the developer is directly supplied to the developing device 14 from the transfer container for transferring the developer by a manual operation by the user. After the developer is supplied to the developing device 14, the transfer container is removed.

The supply of the developer to the developing device 14 is not limited to the manual operation, and may be performed automatically.

Specifically, for example, a conveying member for conveying the developer may be provided inside the transfer container, and after the transfer container is provided in the developing device 14, the conveying member may be operated to automatically supply the developer from the transfer container to the developing device 14.

In this case, after the developer is supplied to the developing device 14, the transfer container is removed.

Here, a configuration in which the developer in which the dry carrier and the dry toner are mixed is directly supplied to the developing device 14 has been described, and a supply mode is not limited thereto.

For example, the transfer container in which only the dry carrier is accommodated and the transfer container in which only the dry toner is accommodated may be prepared, and the dry toner and the dry carrier may be individually supplied to the developing device 14.

Each configuration described above is not limited to the above exemplary embodiment and the modification thereof, and may be changed without departing from the spirit. In other words, it is understood that various modifications in form and details may be made without departing from the purpose and scope of the claims.

For example, some of the configurations described above may be omitted, or other functions may be added to the respective configurations described above.

Although plural configuration examples have been described above, the configuration included in one configuration example may be replaced with the configuration included in another configuration example, or the configuration included in one configuration example may be added to the other configuration example.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus, comprising:
a plurality of image forming units each including an image holding member and configured to form an image that is to be transferred to a recording medium on the image holding member using a dry toner, the number of the plurality of image forming units being at least five; and
a plurality of developing devices each of which is provided in each of the plurality of image forming units and supplied with the dry toner and a dry carrier, each of the plurality of developing devices including a dry toner adhering unit that has a length equal to or longer than a length of a long side of an A3 size and to which the dry toner adheres, the dry toner adhering unit being configured to cause the dry toner adhering to the dry toner adhering unit to adhere to the image holding member.

2. The image forming apparatus according to claim 1, further comprising
a transfer unit configured to transfer the image formed by the image forming unit to the recording medium, and
a reversing mechanism configured to reverse a front and a back of the recording medium having the image transferred on one surface by the transfer unit, and to feed the recording medium to the transfer unit.

3. The image forming apparatus according to claim 1, further comprising
a carrier supply mechanism configured to supply the dry carrier to the plurality of developing devices, and
a toner supply mechanism configured to supply the dry toner to the plurality of developing devices, wherein
a volume of a space of a portion of the carrier supply mechanism through which the dry carrier passes is smaller than a volume of a space of a portion of the toner supply mechanism through which the dry toner passes.

4. The image forming apparatus according to claim 3, wherein
the carrier supply mechanism includes
a common carrier accommodating unit, and
a plurality of movement routes extending from the common carrier accommodating unit toward the plurality of developing devices, and
each of the plurality of movement routes is configured by the portion through which the dry carrier passes.

5. The image forming apparatus according to claim 3, wherein
a supply amount of the dry toner supplied from the toner supply mechanism to the developing device is 1.5 times or more as much as a supply amount of the dry toner of a developing device including the dry toner adhering unit having a length of a short side of the A3 size.

6. The image forming apparatus according to claim 1, further comprising
a carrier supply mechanism configured to supply the dry carrier to the plurality of developing devices, wherein
a value obtained by multiplying a sum of a supply amount per unit time when the dry carrier is supplied to each of the plurality of developing devices and a discharge amount per unit time when the dry carrier is discharged from each of the plurality of developing devices by the number of the image forming units is smaller than a value obtained by multiplying an amount of the dry toner consumed per unit time when the image is formed by each of the image forming units by the number of the image forming units.

7. The image forming apparatus according to claim 1, further comprising
a toner accommodating unit provided at a position different from the plurality of developing devices and configured to accommodate a new dry toner newly supplied from an outside of the image forming apparatus, wherein
the new dry toner is supplied to the plurality of developing devices from the toner accommodating unit.

8. The image forming apparatus according to claim 7, wherein
the new dry toner is supplied to the toner accommodating unit by mounting an accommodating container accommodating the new dry toner on the toner accommodating unit, and
the new dry toner is supplied to the plurality of developing device from the accommodating container mounted in the toner accommodating unit.

9. The image forming apparatus according to claim 1, further comprising
a toner accommodating unit provided at a position different from the plurality of developing devices and configured to accommodate a new dry toner newly supplied from an outside of the image forming apparatus,
a toner replenishing unit configured to receive the dry toner from the toner accommodating unit and replenish the dry toner to the plurality of developing devices,
a carrier accommodating unit that is provided at a position different from the plurality of developing devices and that accommodates a dry carrier newly supplied from the outside of the image forming apparatus, and
a carrier replenishing unit configured to receive the dry carrier from the carrier accommodating unit and replenish the dry carrier to the plurality of developing devices, wherein
a volume of the carrier replenishing unit is smaller than a volume of the toner replenishing unit.

10. The image forming apparatus according to claim 1, further comprising
a toner accommodating unit provided at a position different from the plurality of developing devices and configured to accommodate a new dry toner newly supplied from an outside of the image forming apparatus,
a toner replenishing unit configured to receive the new dry toner from the toner accommodating unit and replenish the dry toner to the plurality of developing devices,
a carrier accommodating unit provided at a position different from the plurality of developing devices and configured to accommodate a dry carrier newly supplied from the outside of the image forming apparatus, and
a carrier replenishing unit configured to receive the dry carrier from the carrier accommodating unit and replenish the dry carrier to the plurality of developing devices, wherein
the new dry toner is supplied to the toner accommodating unit by mounting an accommodating container accommodating the new dry toner on the toner accommodating unit in a mounting direction,
the toner replenishing unit replenishes the new dry toner to the plurality of developing devices after the new dry toner is conveyed along the mounting direction of the accommodating container,
the carrier replenishing unit replenishes the dry carrier to the plurality of developing devices after the dry carrier is conveyed along the mounting direction, and
a length of the carrier replenishing unit in the mounting direction is shorter than a length of the toner replenishing unit in the mounting direction.

11. The image forming apparatus according to claim 1, further comprising
a toner accommodating unit provided at a position different from the plurality of developing devices and configured to accommodate a new dry toner newly supplied from an outside of the image forming apparatus,
a toner replenishing unit configured to receive the new dry toner from the toner accommodating unit and replenish the new dry toner to the plurality of developing devices,
a carrier accommodating unit provided at a position different from the plurality of developing devices and configured to accommodate a dry carrier newly supplied from the outside of the image forming apparatus, and
a carrier replenishing unit configured to receive the dry carrier from the carrier accommodating unit and replenish the dry carrier to the plurality of developing devices, wherein
the new dry toner is supplied to the toner accommodating unit by mounting an accommodating container accommodating the new dry toner on the toner accommodating unit in a mounting direction, and
a cross-sectional area of the carrier replenish unit perpendicular to the mounting direction of the accommodating container is smaller than a cross-sectional area of the toner replenish unit perpendicular to the mounting direction of the accommodating container.

12. The image forming apparatus according to claim 1, further comprising
a toner accommodating unit provided at a position different from the plurality of developing devices and configured to accommodate a dry toner newly supplied from an outside of the image forming apparatus,
a toner replenishing unit configured to receive the dry toner from the toner accommodating unit and replenish the dry toner to the plurality of developing devices,
a carrier accommodating unit provided at a position different from the plurality of developing devices and configured to accommodate a dry carrier newly supplied from the outside of the image forming apparatus, and
a carrier replenishing unit configured to receive the dry carrier from the carrier accommodating unit and replenish the dry carrier to the plurality of developing devices, wherein
the toner replenishing unit causes the dry toner to fall to replenish the dry toner to the plurality of developing devices, and
the carrier replenishing unit causes the dry carrier to fall from vertically above the toner replenishing unit to replenish the dry carrier to the plurality of developing devices.

13. The image forming apparatus according to claim 1, further comprising
a toner accommodating unit provided at a position different from the plurality of developing devices and configured to accommodate a new dry toner newly supplied from an outside of the image forming apparatus, and
a carrier accommodating unit provided at a position different from the plurality of developing devices and configured to accommodate a dry carrier newly supplied from the outside of the image forming apparatus, wherein
the new dry toner is supplied to the toner accommodating unit by mounting an accommodating container accommodating the new dry toner on the toner accommodating unit in a mounting direction, and
a length of the carrier accommodating unit in the mounting direction of the accommodating container is shorter than a length of the toner accommodating unit in the mounting direction of the accommodating container.

14. The image forming apparatus according to claim 1, further comprising
a toner accommodating unit provided at a position different from the plurality of developing devices and configured to accommodate a dry toner newly supplied from an outside of the image forming apparatus, and
a carrier accommodating unit provided at a position different from the plurality of developing devices and configured to accommodate a dry carrier newly supplied from the outside of the image forming apparatus, wherein
a lowermost portion of the carrier accommodating unit in a vertical direction is located vertically below a lowermost portion of the toner accommodating unit in the vertical direction.
